(19) United States
(12) Patent Application Publication
(10) Pub. No.: US 2024/0346432 A1
(43) Pub. Date: Oct. 17, 2024

(54) SYSTEMS, METHODS, AND APPARATUS TO AUTOMATE CONSUMER ADVOCACY WITH A LARGE LANGUAGE MODEL

(71) Applicant: Returned.com, Inc., Boulder, CO (US)

(72) Inventors: Patrick A. Justis, Longmont, CO (US); Paul Pao-Yen Lin, Boulder, CO (US)

(21) Appl. No.: 18/633,327

(22) Filed: Apr. 11, 2024

Related U.S. Application Data
(60) Provisional application No. 63/495,963, filed on Apr. 13, 2023.

(51) Int. Cl. G06Q 10/0837; G06Q 30/016

(52) U.S. Cl. CPC G06Q 10/0837; G06Q 30/016

(57) ABSTRACT

Systems, apparatus, articles of manufacture, and methods to automate consumer advocacy with a large language model are disclosed. Machine readable instructions may be executed to cause at least one programmable circuit to at least obtain a first message from a large language model based on a return request provided by a consumer, the return request associated with a previously purchased product to be returned to an entity, cause transmission of the first message to the entity to request authorization of the return of the previously purchased product, obtain a second message from the large language model, the second message based on the first message and a first response, the first response from the entity in response to the first message, cause transmission of the second message to the entity to continue the request to return the previously purchased product, and cause communication of a resolution message to the consumer.

### RELATED APPLICATION

This patent claims the benefit of U.S. Provisional Patent Application No. 63/495,963, which was filed on Apr. 13, 2023. U.S. Provisional Patent Application No. 63/495,963 is hereby incorporated herein by reference in its entirety. Priority to U.S. Provisional Patent Application No. 63/495,963 is hereby claimed.

### FIELD OF THE DISCLOSURE

This disclosure relates generally to artificial intelligence and, more particularly, to systems, methods, and apparatus to automate consumer advocacy with a large language model.

### BACKGROUND

Entities with which a consumer may interact usually have policies, systems, and procedures that support their interactions with their consumers. Such policies, systems, and procedures may include automated prompts, call centers, email addresses, etc. with which a consumer may interact with the entity. Some of these policies, systems, and procedures are marketed as being supportive of the consumer.

### BRIEF DESCRIPTION OF THE DRAWINGS

FIG. 1 is a block diagram of an example environment in which an example consumer advocacy system operates to automatically advocate on behalf of a consumer.

FIG. 2 is a block diagram of an example implementation of the consumer advocacy system of FIG. 1.

FIG. 3 is a communication diagram representing example communications between a consumer device, the consumer advocacy system of FIG. 1, the large language model of FIG. 2, and the entity of FIG. 1.

FIG. 4 is a flowchart representative of example machine readable instructions and/or example operations that may be executed, instantiated, and/or performed by example programmable circuitry to implement the consumer advocacy system 115 of FIG. 2 to handle a request for coordination of a return from a consumer.

FIG. 5 is a flowchart representative of example machine readable instructions and/or example operations that may be executed, instantiated, and/or performed by example programmable circuitry to implement the consumer advocacy system 115 of FIG. 2 to communicate with an entity on behalf of a consumer.

FIG. 6 is a flowchart representative of example machine readable instructions and/or example operations that may be executed, instantiated, and/or performed by example programmable circuitry to implement the consumer advocacy system 115 of FIG. 2 to determine a next action to perform during the conversation with the entity.

FIG. 7 is a flowchart representative of example machine readable instructions and/or example operations that may be executed, instantiated, and/or performed by example programmable circuitry to implement the consumer advocacy system 115 of FIG. 2 to monitor for an event during the conversation with the entity.

FIG. 8 is a flowchart representative of example machine readable instructions and/or example operations that may be executed, instantiated, and/or performed by example programmable circuitry to implement the consumer advocacy system 115 of FIG. 2 to observe and determine a status of the conversation with the entity.

FIG. 9 is a flowchart representative of example machine readable instructions and/or example operations that may be executed, instantiated, and/or performed by example programmable circuitry to implement the consumer advocacy system 115 of FIG. 2 to process a consumer next task.

FIG. 10 is a flowchart representative of example machine readable instructions and/or example operations that may be executed, instantiated, and/or performed by example programmable circuitry to implement the consumer advocacy system 115 of FIG. 2 to process an entity next task.

FIG. 11 is a flowchart representative of example machine readable instructions and/or example operations that may be executed, instantiated, and/or performed by example programmable circuitry to implement the consumer advocacy system 115 of FIG. 2 to review conversation log(s) to identify one or more patterns.

FIG. 12 is a flowchart representative of example machine readable instructions and/or example operations that may be executed, instantiated, and/or performed by example programmable circuitry to implement the consumer advocacy system 115 of FIG. 2 to review entity policy(ies).

FIG. 13 is a flowchart representative of example machine readable instructions and/or example operations that may be executed, instantiated, and/or performed by example programmable circuitry to implement the consumer advocacy system 115 of FIG. 2 to review conversation log(s) to detect communication issues.

FIGS. 14, 15, 16, and 17 are example communication diagrams representing example conversations between the consumer advocacy system and the entity of FIG. 1.

FIG. 18 is a block diagram of an example processing platform including programmable circuitry structured to execute, instantiate, and/or perform the example machine readable instructions and/or perform the example operations of FIGS. 4-14 to implement the consumer advocacy system 115 of FIG. 2.

FIG. 19 is a block diagram of an example implementation of the programmable circuitry of FIG. 18.

FIG. 20 is a block diagram of another example implementation of the programmable circuitry of FIG. 18.

FIG. 21 is a block diagram of an example software/firmware/instructions distribution platform (e.g., one or more servers) to distribute software, instructions, and/or firmware (e.g., corresponding to the example machine readable instructions of FIGS. 4-14) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Consumers routinely interact with entities to purchase goods, services, etc. Some entities implement systems and/or policies by which a consumer may interact with the entity. Example systems may include call centers, web-based customer service agents, web-based forms and/or webpages, email addresses, etc. that allow a consumer to interact with the entity. Such interactions may support various actions conducted between the consumer and the entity such as, for example, returning a purchased item, negotiating a new price for a service, etc. Some entities may invest in infrastructure that enables such interactions to be conducted in an efficient manner for a consumer.

For example, some retailers enable a consumer to fill out a return form on a website by clicking a link and requesting the return of an item. However, not all entities are user-friendly. Some entities might implement text-based (e.g., a web-based chat session, a Short Message Service (SMS) chat session, an email address) customer service agent(s), and/or voice-based (e.g., a telephonic voice session) customer service agent(s) with which the consumer may interact. In such instances, interacting with such text-based and/or telephone-based customer service agents might be overly time-consuming for consumers. Moreover, because different entities might use different customer service systems, consumers are faced with understanding different systems for interacting with the different entities.

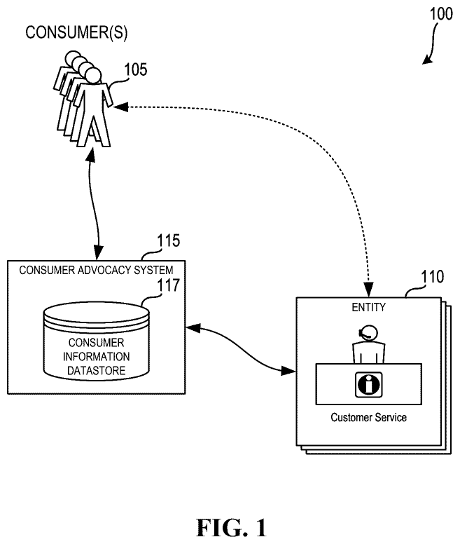

FIG. 1 is a diagram illustrating an example environment of use 100 in which a consumer 105 may interact with an entity 110. In the illustrated example of FIG. 1, a consumer advocacy system 115 facilitates (e.g., automates) interaction between the consumer 105 and the entity 110.

The example consumer 105 represents a person, citizen, customer, individual, employee, purchasing agent, government agent, corporation, etc. that purchased and/or received a good and/or service from the entity 110. In the illustrated example of FIG. 1, multiple consumers are shown representing the multitude of consumers that exist. Consumers may have different levels of ability for interacting directly with various entities (represented by the dotted line intermediate the consumer 105 and the entity 110). For example, consider a scenario in which a Spanish-speaking consumer may desire to return a purchased item to an entity that only supports English interactions. In such an example, the Spanish-speaking consumer may find it difficult to return the item and/or interact with the entity. In some other examples, a consumer may prefer not to use a text-based (e.g., chat) interaction with the entity. As such, the techniques by which a consumer may interact with an entity may be a source of frustration for consumers, potentially leading to a consumer finding a different entity to interact with (e.g., purchase from) in the future and/or to the consumer being unable or unwilling to return an unwanted or unsuitable (e.g., defective) item.

The example entity 110 of FIG. 1 represents a company, government, agency, department, etc. with which a consumer may desire to interact. Entity 110 may be, for example, a seller who provides a good and/or service to the consumer 105. The good and/or service may or may not be purchased for value (e.g., the service may be a free service or a paid service). A customer service agent of the entity 110 (sometimes referred to simply as an agent) may include, for example, customer service agents, chat bots, salespeople, and perhaps anyone representing the entity (including contracted third parties).

In some examples, the entity 110 provides various communication mediums that enable a consumer (or the consumer advocacy system 115) to interact with the entity 110. Such systems may include, for example, one or more electronic platforms which may provide and/or enable interaction via email addresses, web forms, chat agents, telephonic agents, etc.

In some examples, the entity 110 may be a simulated entity. That is, rather than being an actual company, government, agency, etc. the entity may be simulated by the consumer advocacy system 115 to enable development and/or testing of the systems operated by the consumer advocacy system 115. In other words, instead of communicating with an agent operating on behalf of a real third party entity, the consumer advocacy system 115 may communicate with an agent masquerading as a representative of the real third party. This agent may be implemented by an administrator of the consumer advocacy system 115. Using a simulated entity allows for various patterns, prompt templates, messages, formats, etc. to be tested without interfering with the operations of a real third-party entity or risking the mishandling of a return on behalf of a consumer.

The example consumer advocacy system 115 of the illustrated example of FIG. 1 facilitates interaction between the consumer 105 and the entity 110. The consumer advocacy system 115 may be accessed by the consumer 105 using an application (e.g., an “app” installed on a user device), may be accessed via a website, chatted with, and/or may be talked to via other communication methods (e.g., a telephone call, an SMS message, etc.). Advantageously, the consumer advocacy system disclosed herein provides an interface with which consumers may interact with multiple different entities, rather than having to learn how to interact with various systems utilized by different entities.

As noted above, interactions between consumers and entities may be conducted through a multitude of different channels including, for example, website chats, phone calls, emails, etc. The example consumer advocacy system 115 of FIG. 1 supports consumers by handling such interactions with entities and/or agents of the entities. In many scenarios, the consumer advocacy system eliminates the need for the consumer to directly interact with the entity and/or its agents. Advantageously, such an approach also enables consumers to more easily interact with entities and/or its agents that do not speak the language of the consumer(s). Returning to the Spanish-speaking consumer situation described above, the Spanish-speaking consumer may interact with the consumer advocacy system 115 using their preferred language (e.g., Spanish), while the consumer advocacy system 115 may interact with the entity 110 in a different language (e.g., English). That is, a return request may be received in a first natural language (e.g., English, Spanish, German, French, Japanese, Chinese, Korean, etc.), and the conversation with the entity may be carried out in a second natural language (e.g., English, Spanish, German, French, Japanese, Chinese, Korean, etc.) that is different from the first natural language.

In the illustrated example of FIG. 1, the example consumer advocacy system 115 includes a consumer information datastore 117 that includes information about consumer preferences, which guides the interactions between the consumer advocacy system 115 and the entity 110 on behalf of the consumer 105. In this manner, the consumer advocacy system 115 enables user preferences (e.g., “I would rather not provide images of a product to be returned”, “I would prefer to drop off returns within 2 miles of a particular address,” etc.) to be adhered to, when possible.

While some examples disclosed herein focus on retail type agreements and/or transactions, many other types of agreements and/or accounts may additionally or alternatively be used and/or supported. For example, various types of retail accounts, service accounts, subscription services, business to business agreements, wholesale to retailer relationships, consumer to wholesaler, etc. may be supported by the consumer advocacy system 115.

With respect to retail accounts, example approaches disclosed herein may be utilized to analyze transactions, orders, receipts, loyalty points and/or rewards programs, buy now, pay later, and/or other interactions. For example, the system could be utilized to automatically negotiate discounts or special offers on behalf of consumers when making purchases. Examples disclosed herein may track and manage loyalty points or rewards programs (e.g., airline miles) for consumers.

With respect to service accounts (e.g., accounts used for providing services), examples disclosed herein may be utilized to interact with an entity and/or one or more agents of an entity providing the service. Such service(s) may include, for example, cell phone contracts, gym memberships, warranty services, service contracts (e.g., home appliance repair contracts, vehicle service contracts, electronics maintenance contracts, etc.), maintenance agreements (e.g., home cleaning services, etc.), insurance policies, television service agreements (e.g., cable television), Internet access agreements, Utility service (e.g., electric service, natural gas service, etc.) etc. Examples disclosed herein may interact with a service provider to, for example, negotiate a lower rate, modify contract terms, cancel service, etc. In some examples, the consumer advocacy system may be utilized to automatically manage subscription renewals and/or cancellations on behalf of consumers, allowing them to stay informed about their obligations under the subscription agreement. In some examples, subscription terms and conditions are tracked and/or managed for consumers, allowing them to make informed decisions when subscribing to a service.

With respect to subscription services (e.g., regularly recurring services), example approaches disclosed herein may be utilized to interact with an entity and/or one or more agents of an entity providing the subscription service. Such subscriptions services may include, for example, any of the services mentioned above, and/or media streaming services (e.g., video streaming, audio streaming, music streaming, audio book services, etc.), online gaming services, magazine and/or newspaper subscription services, meal delivery services, application services (e.g., computer and/or phone applications), etc. Examples disclosed herein may track the services utilized by a consumer and interact with the provider of the subscription to, for example, alter the terms under which the service is provided. The contact with the subscription service provider may, in some examples, be made at the direction of the consumer (e.g., in response to a suggestion made by the consumer advocacy system disclosed herein). For example, the example consumer advocacy system may, upon determination that a consumer has a gym membership, but has not visited the gym in the last three months, recommend to the consumer that the example consumer advocacy system interact with the gym to cancel the membership or alter the terms thereof. More generally, the example consumer advocacy system may determine that a subscription service is not being utilized (or is being under-utilized) and may prompt a consumer to request the consumer advocacy system to attempt to negotiate better terms for the contract on the consumer's behalf.

Example approaches disclosed herein may be utilized in the context of many different types of services, accounts, and/or agreements. For example, in addition to and/or instead of any of the services mentioned in elsewhere in this document, utility accounts (e.g., electricity service, natural gas services, water service, sewer service, telephone service, television service, internet service, etc.), rental and/or lease agreements (e.g., residential housing leases/agreements, commercial leases/agreements, vehicle leases/agreements, equipment leases/agreements, etc.), insurance agreements (e.g., life insurance, home insurance, auto insurance, travel insurance, etc.), financial services (e.g., banking services, checking services, savings services, credit services, loan services, investment services, brokerage services, etc.) may be managed on behalf of a consumer by the consumer advocacy system.

Beyond services that a consumer might receive, there are many different organizations with which a consumer may desire to interact. The example consumer advocacy system disclosed herein can be utilized to facilitate interactions with such other organizations for the benefit of the consumer. For example, the example entity 110 of FIG. 1 may represent a government entity providing services and/or benefits to a consumer including for example, unemployment benefits, social security, disability benefits, public assistance programs, licenses and/or permits, tax services, voting facilitation, identification services, healthcare services, education services, etc.

Moreover, the example consumer advocacy system 115 of FIG. 1 supports other interactions between a consumer and an entity and/or its agents (which may be a contracted third party) including, for example, status requests (e.g., service outage information requests, delivery status requests, shipping and delivery update requests, order status requests, gift card balance inquiries, etc.), reporting information (e.g., product review submissions, fraud prevention and/or identify theft reporting, etc.), or other directed inquiries (e.g., price adjustment requests, event registration and/or appointment scheduling requests, donation and/or fundraising requests, product inquiries, product recall information requests, etc.).

To accomplish such tasks, the example consumer advocacy system 115 tracks information about such relationships between consumers and entities including, for example, customer service policies and/or business practices; eligibility of consumer accounts, purchases, and/or contracts; timing and/or expiration of products (e.g., return windows), services, and/or contracts; typically used documentation, reference numbers, account information, etc. and/or approaches for executing resolution of inquiries (e.g., apply refund to a credit card, bank account(s), and/or other financial account(s); preferred shipping channels; time frames for policies; expected fees; requirements for providing additional information; etc.)

Thus, while example approaches disclosed herein are described in the context of a retail product return, persons of ordinary skill in the art will readily recognize that the example consumer advocacy system 115 disclosed herein can be easily adapted to other problems, activities, and/or fields.

In some examples, an entity 110 may desire to prevent automated systems from interacting with the entity. Preventing such interactions may make it more difficult for consumers to return items, to the financial benefit of the entity. To that end, an entity may attempt to analyze messages communicated to the entity to attempt to detect whether those messages are being sent by a consumer or an automated system such as a consumer advocacy system and, upon detection that the message was transmitted by the consumer advocacy system (or other automated entity), the entity 110 may take some sort of precautionary measure (e.g., a responsive action) to, for example, prevent future automated messages from being received from the consumer advocacy system. Such precautionary measure may include, for example, issuing a Completely Automated Public Turing test to tell Computers and Humans Apart (CAPTCHA), issuing a prompt to request a particular response, blocking and/or terminating a communication session, etc.

To combat such preventative measures, in some examples, the example consumer advocacy system may introduce typographic errors and/or other features that make communications appear to be more human-like. For example, typographic errors that involve characters near other characters on a keyboard might be introduced to a message before sending the message to the entity 110.

To enable interaction with the entity, the example consumer advocacy system 115 of examples disclosed herein utilizes artificial intelligence and/or other machine learning systems. Artificial intelligence (AI), including machine learning (ML), deep learning (DL), Large Language Models (LLMs) and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and leverage such patterns and/or associations when processing input data such that other input(s) result in output(s) consistent with the recognized patterns and/or associations.

Many different types of machine learning models and/or machine learning architectures exist. In examples disclosed herein, a Large Language Model (LLM), such as ChatGPT, is used. Using an LLM enables customized messages to be generated. In general, machine learning models/architectures that are suitable to use in the example approaches disclosed herein will be transformer-type models, that receive one or more inputs, and generate a corresponding output (e.g., a textual message). However, other types of machine learning models could additionally or alternatively be used.

In general, implementing a ML/AJ system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AJ model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AJ model (e.g., without the benefit of expected (e.g., labeled) outputs).

Once training is complete, the model is deployed for use as an executable construct (e.g., software instructions) that processes an input and provides an output. Such execution of the model is often referred to as an inference phase. In the inference phase, data to be analyzed (e.g., live data) is input to the model, and the model is executed to create an output. This inference phase can be thought of as the Al “thinking” to generate the output based on what was learned from the training and/or fine-tuning (e.g., by executing the model to apply the learned patterns and/or associations to the live data). In some examples, input data undergoes pre-processing before being used as an input to the machine learning model. Moreover, in some examples, the output data may undergo post-processing after it is generated by the model to transform the output data into a useful result (e.g., a display of data, an instruction to be executed by a machine, etc.).

In some examples, the trained model is executed by a third-party entity (e.g., a service provider). Such a third party might not have any interest in the result of the executed model except for providing that result to the party that requested the execution of the model. In some other examples, the trained model is executed by the entity seeking the result of the execution of the trained model (e.g., the model is locally executed on hardware owned and/or operated by the entity requesting execution).

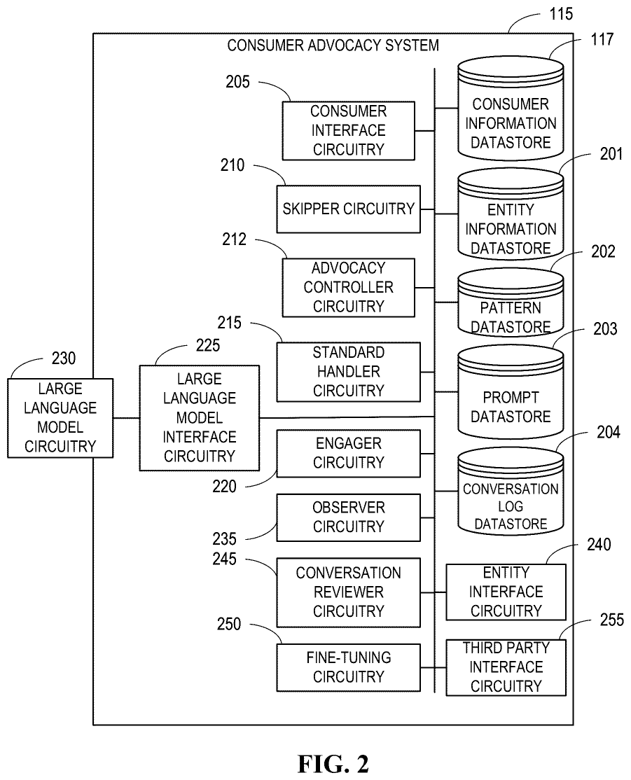

FIG. 2 is a block diagram of an example implementation of the consumer advocacy system 115 of FIG. 1 to automate consumer advocacy tasks with a large language model (LLM). The consumer advocacy system 115 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the consumer advocacy system 115 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example consumer advocacy system 115 of the illustrated example of FIG. 2 includes the consumer information datastore 117, an entity information datastore 201, a pattern datastore 202, a prompt datastore 203, and a conversation log datastore 204. Further, the example consumer advocacy system 115 of the illustrated example of FIG. 2 includes consumer interface circuitry 205, skipper circuitry 210, advocacy controller circuitry 212, standard handler circuitry 215, engager circuitry 220, large language model interface circuitry 225, large language model circuitry 230, observer circuitry 235, entity interface circuitry 240, conversation reviewer circuitry 245, fine-tuning circuitry 250, and third-party interface circuitry 255.

The example consumer information datastore 117, the example entity information datastore 201, the example pattern datastore 202, the example prompt datastore 203, and the example conversation log datastore 204 of the illustrated example of FIG. 2 are implemented by any memory, storage device and/or storage disc for storing data such as, for example, flash memory, magnetic media, optical media, solid state memory, hard drive(s), thumb drive(s), etc. Furthermore, the data stored in the example consumer information datastore 117, the example entity information datastore 201, the example pattern datastore 202, the example prompt datastore 203, and the example conversation log datastore 204 may be in any data format such as, for example, binary data, comma delimited data, tab delimited data, structured query language (SQL) structures, etc. While, in the illustrated example, the example consumer information datastore 117, the example entity information datastore 201, the example pattern datastore 202, the example prompt datastore 203, and the example conversation log datastore 204 are illustrated as separate devices, in some examples, the example consumer information datastore 117, the example entity information datastore 201, the example pattern datastore 202, the example prompt datastore 203, and the example conversation log datastore 204 may be implemented in a same data storage device.

In general, the example consumer information datastore 117 stores information about the consumer and/or advocacy request received in association with the consumer. In some examples, the example consumer information datastore 117 of the illustrated example of FIG. 2 stores information about consumer preferences that guides the interactions between the consumer advocacy system 115 and the entity 110 on behalf of the consumer 105. In this manner, the consumer advocacy system 115 enables user preferences (e.g., “I would rather not provide images of a product to be returned”, “I would prefer to drop off returns within 2 miles of a particular address,” etc.) to be adhered to. In some examples, the consumer information datastore 117 stores order information associated with a return that the consumer has requested. In some examples, consumer next tasks are stored in the consumer information datastore 117. Such consumer next tasks enable identification of tasks that are to be performed by a consumer to complete various objectives (e.g., deliver an item to a courier drop-off location).

The example entity information datastore 201 of the illustrated example of FIG. 2 stores information related to communications with an entity. Such information may include, for example, instructions related to navigating pre-communication prompts, entity policies, entity item data, entity service data, and/or other entity information. In some examples, entity next tasks are stored in the entity information datastore 201. Such entity next tasks enable identification of tasks that are to be performed by the entity.

The example pattern datastore 202 of the illustrated example of FIG. 2 stores one or more patterns for use by the example standard handler circuitry 215. Such patterns enable the standard handler circuitry 215 to determine the status of a conversation and/or to determine the next action to be performed as part of a conversation. In examples disclosed herein, the patterns are implemented as regular expressions or other types of patterns that may be used to extract and/or parse information from a conversation. In some examples, the pattern datastore 202 stores instructions and/or configuration information that enables status updates to be stored as a result of a matched pattern.

The example prompt datastore 203 of the illustrated example of FIG. 2 stores prompt templates that may be utilized by the example observer circuitry 235 and/or the example engager circuitry 220 to generate prompts to be provided to the LLM circuitry 230.

The example conversation log datastore 204 of the illustrated example of FIG. 2 stores conversation logs representing communications between the consumer advocacy system 115 and the entity 110. In some examples, communications between the consumer advocacy system 115 and the LLM circuitry 230 are also stored in the conversation logs. Such communications between the consumer advocacy system 115 and the LLM circuitry 230 represent prompts provided to the LLM circuitry 230 and/or responses to prompts from the LLM circuitry 230.

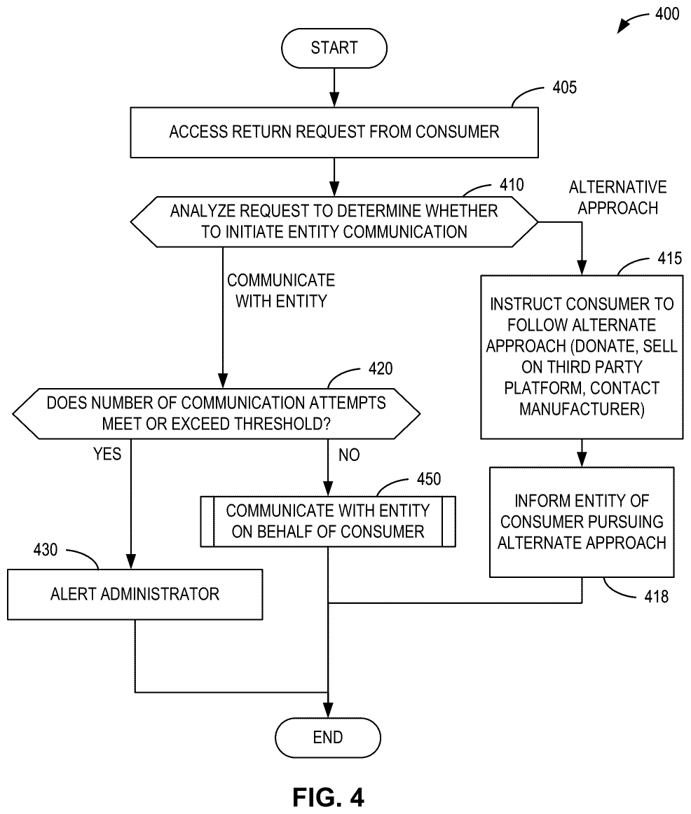

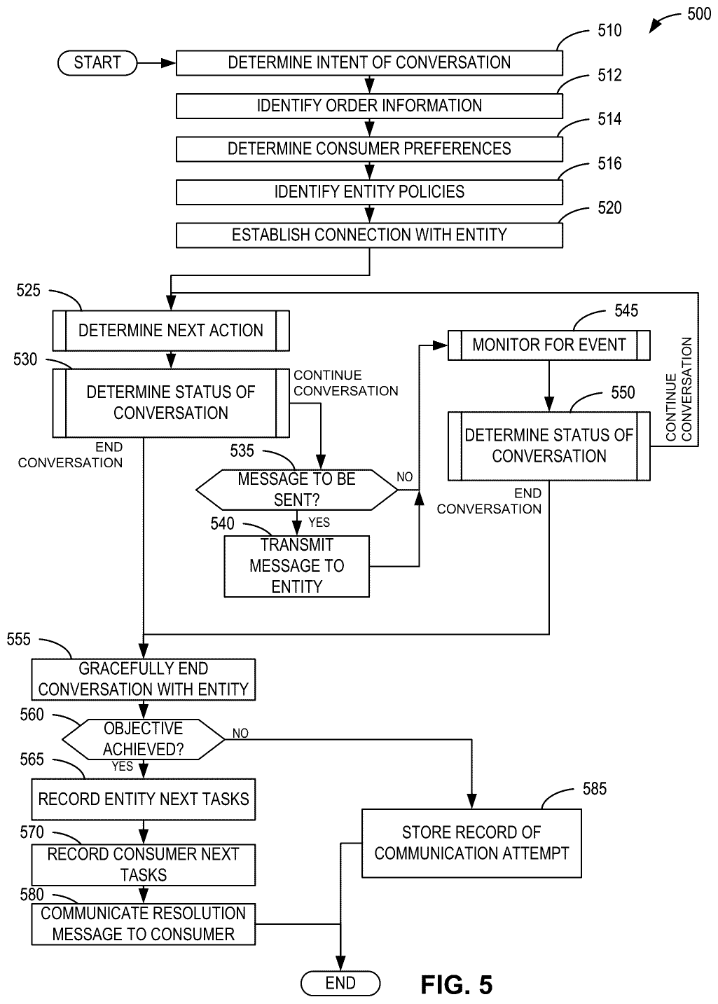

The example consumer interface circuitry 205 of the illustrated example of FIG. 2 enables the consumer 105 to interact with the consumer advocacy system 115. In some examples, the consumer interface circuitry 205 is instantiated by programmable circuitry executing consumer interface instructions and/or configured to perform operations such as those represented by the flowchart(s) of FIGS. 4, 5, and/or 9.

In some examples, the consumer interface circuitry 205 provides a web interface (e.g., a website, an application programming interface (API)), by which the consumer 105 of FIG. 1 may interact with the consumer advocacy system 115 to submit an advocacy request (e.g., “please return this item for me”). In some examples, the interface enables other modes of communication (e.g., telephonic communication, text-based communication, etc.). In some examples, the consumer 105 utilizes an application (e.g., an app) or a browser to provide their advocacy request to the consumer interface circuitry 205.

Moreover, in some examples, the consumer interface circuitry 205 enables the consumer advocacy system 115 to communicate messages to the consumer. Such messages may be communicated by way of an email message, an in-app notification, an SMS message, etc. Such messages may include resolution messages that indicate the resolution of a request for consumer advocacy. In some examples, the consumer interface circuitry 205 provides reminder messages to remind the consumer to perform a consumer next task (e.g., deliver an item to a courier drop-off location, etc.).

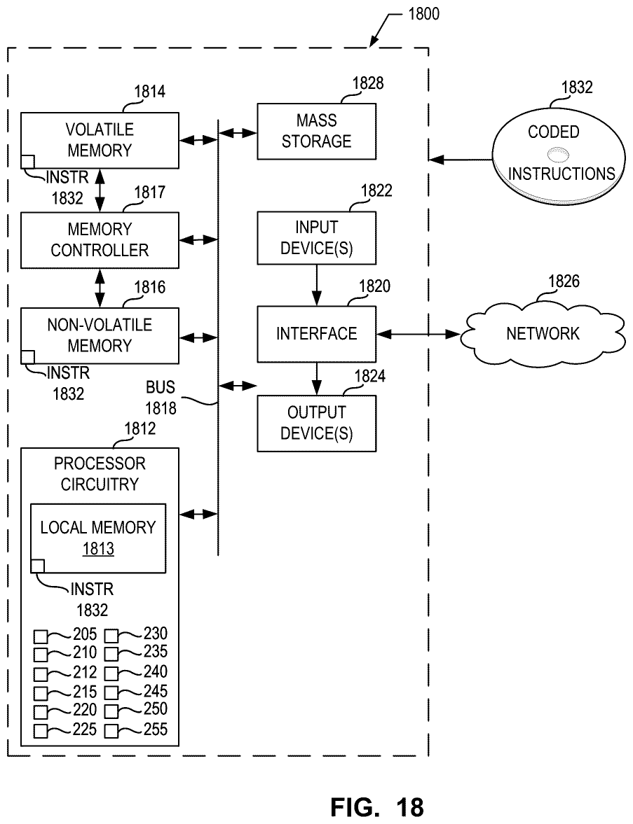

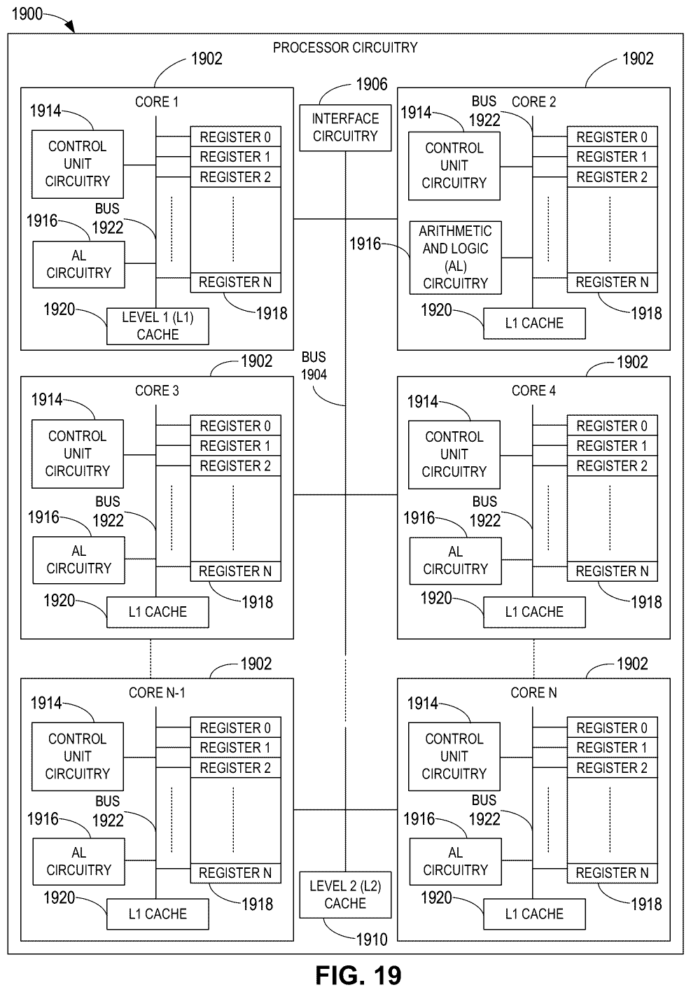

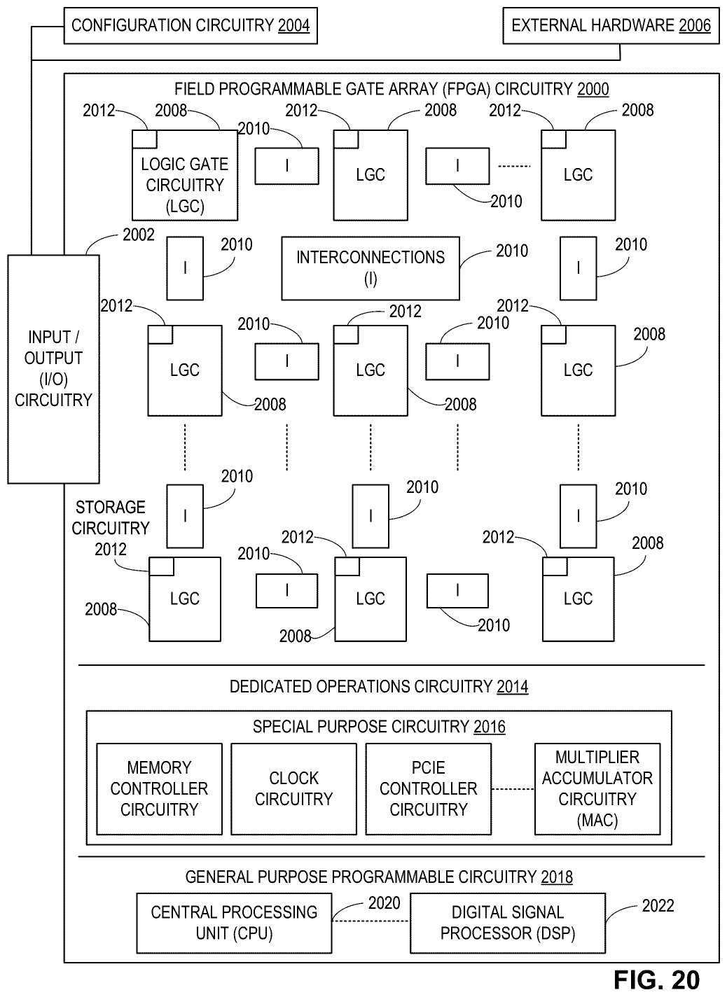

In some examples, the consumer advocacy system 115 includes means for interfacing with a consumer. For example, the means for interfacing with a consumer may be implemented by consumer interface circuitry 205. In some examples, the consumer interface circuitry 205 may be instantiated by programmable circuitry such as the example programmable circuitry 1812 of FIG. 18. For instance, the consumer interface circuitry 205 may be instantiated by the example microprocessor 1900 of FIG. 19 executing machine executable instructions such as those implemented by at least blocks 405, 415, 910, 930, 940, 950, 960, 970, 980 of FIGS. 4 and/or 9. In some examples, the consumer interface circuitry 205 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the consumer interface circuitry 205 may be instantiated by any other combination of hardware, software, and/or firmware. For example, the consumer interface circuitry 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example skipper circuitry 210 of the illustrated example of FIG. 2 analyzes requests received via the consumer interface circuitry 205 to determine whether the request should result in communication with the entity. In some examples, the skipper circuitry 210 is instantiated by programmable circuitry executing skipper instructions and/or configured to perform operations such as those represented by the flowchart(s) of FIG. 4.

The example skipper circuitry 210 analyzes a request to determine whether to initiate communication with the entity on behalf of the consumer. To make such a determination, the example skipper circuitry 210 reviews the return request in connection with information about the entity, information about consumer, etc. to determine whether the requested action return is a preferred (e.g., most economical) option for the consumer. In some examples, the consumer might have requested to return an item that the entity will not take back. For example, some online retailers have policies that do not allow for the return of food items. In such cases, the example skipper circuitry 210 may instruct the consumer to follow an alternative approach such as, for example, donating the food item to a food pantry (e.g., assuming the item is still consumable).

In some examples, the example skipper circuitry 210 causes the entity interface circuitry 240 to inform the entity of the consumer pursuing the alternate approach via the entity interface circuitry 240. In some examples, it may be advantageous for the entity to be informed that the consumer would have returned an item, but chose to follow an alternative approach.

In some examples, the consumer advocacy system 115 includes means for skipping a conversation. For example, the means for skipping may be implemented by skipper circuitry 210. In some examples, the skipper circuitry 210 may be instantiated by programmable circuitry such as the example programmable circuitry 1812 of FIG. 18. For instance, the skipper circuitry 210 may be instantiated by the example microprocessor 1900 of FIG. 19 executing machine executable instructions such as those implemented by at least blocks 410, 415, 418, 420, 430 of FIG. 4. In some examples, the skipper circuitry 210 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the skipper circuitry 210 may be instantiated by any other combination of hardware, software, and/or firmware. For example, the skipper circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example advocacy controller circuitry 212 of the illustrated example of FIG. 2 controls various operations of the example consumer advocacy system 115. For example, the advocacy controller circuitry 212 may organize values (e.g., status variables) prior to initiation of a connection with an entity. To that end, the example advocacy controller circuitry 21 may determine an intent of a conversation, identify order information, determine consumer preferences, identify entity policies, etc. prior to establishing a connection with an entity. Moreover, after communication with an entity is complete, the example advocacy controller circuitry 212 may review results of the conversation to determine whether objective(s) were achieved, whether any additional next tasks are to be performed (e.g., consumer next tasks, entity next tasks, etc.).

In some examples, the consumer advocacy system 115 includes means for controlling advocation for a consumer. For example, the means for controlling may be implemented by advocacy controller circuitry 212. In some examples, the advocacy controller circuitry 212 may be instantiated by programmable circuitry such as the example programmable circuitry 1812 of FIG. 18. For instance, the advocacy controller circuitry 212 may be instantiated by the example microprocessor 1900 of FIG. 19 executing machine executable instructions such as those implemented by at least blocks 510, 512, 514, 516, 560, 565, 570, 580, 585 of FIG. 5. In some examples, the advocacy controller circuitry 212 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the advocacy controller circuitry 212 may be instantiated by any other combination of hardware, software, and/or firmware. For example, the advocacy controller circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

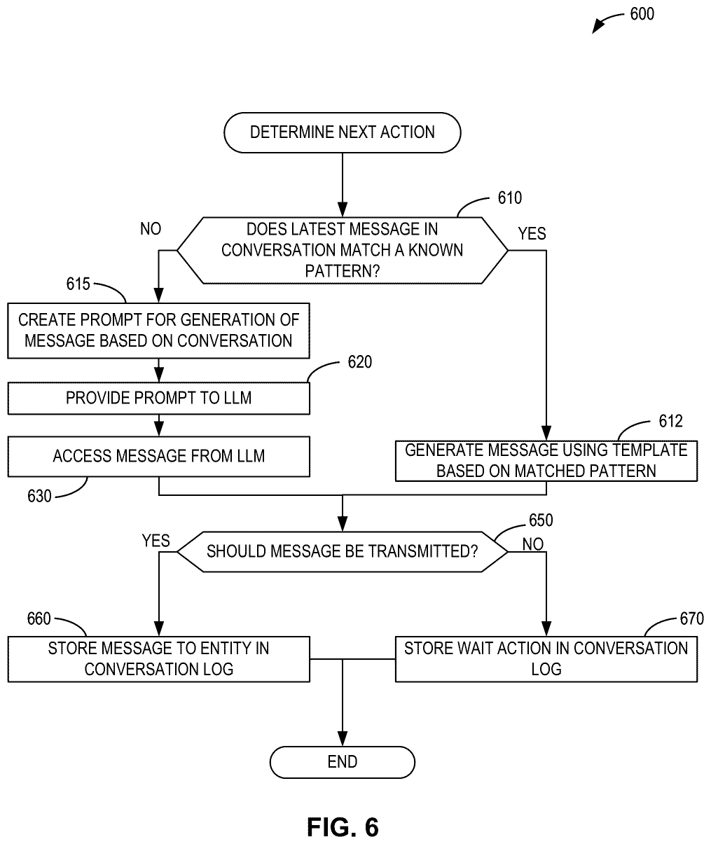

The example standard handler circuitry 215 of the illustrated example of FIG. 2 applies patterns to detect a status of a conversation and/or determine a next message to be communicated. In some examples, the standard handler circuitry 215 is instantiated by programmable circuitry executing standard handler instructions and/or configured to perform operations such as those represented by the flowchart(s) of FIGS. 5, 6, and/or 8.

The example standard handler circuitry 215 utilizes patterns and/or other data extraction techniques to detect information in a conversation. In this manner, the example standard handler circuitry 215 can be used in concert with the engager circuitry 220 to, when a pattern of communication is detected that has a predictable next action, follow that next action, instead of utilizing the engager circuitry 220 to determine that next action. For example, if an agent of the entity were to ask “what is your order number?”, it should be anticipated that the next statement to the agent would be a message including an order number. The example standard handler circuitry 215 detects that the request from the agent matches a known pattern (e.g., a pattern identifying a request for an order number and/or other purchase record), which has a following subsequent response of “the order number is ORDER_NUMBER”. Thus, instead of utilizing the engager circuitry 220 to cause the LLM circuitry 230 to generate a message replying with the order number, the example standard handler circuitry 215 can identify that this standardized message should be used instead. Using this approach reduces the computational overhead of executing a large language model in situations where patterns having predictable next actions are known.

Advantageously, the example standard handler circuitry 215 may additionally or alternatively be utilized in concert with the example observer circuitry 235. As explained below, the example observer circuitry 235 creates a prompt to cause the LLM 230 to identify one or more status variables identifying a status of a conversation. In examples disclosed herein, the example standard handler circuitry 215 may be utilized to detect such status variables based on identified patterns.

In some examples, the consumer advocacy system 115 includes means for handling standard conditions. For example, the means for handling may be implemented by standard handler circuitry 215. In some examples, the standard handler circuitry 215 may be instantiated by programmable circuitry such as the example programmable circuitry 1812 of FIG. 18. For instance, the standard handler circuitry 215 may be instantiated by the example microprocessor 1900 of FIG. 19 executing machine executable instructions such as those implemented by at least blocks 525, 530, 545, 550, 610, 612, 650, 660, 670, 810, 815, 820, 825, 830, 845, 850, 855 of FIGS. 5, 6, and/or 8. In some examples, the standard handler circuitry 215 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the standard handler circuitry 215 may be instantiated by any other combination of hardware, software, and/or firmware. For example, the standard handler circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example engager circuitry 220 of the illustrated example of FIG. 2 generates prompts to be utilized by the LLM circuitry 230 to create a message for transmission to the entity 110. In some examples, the engager circuitry 220 is instantiated by programmable circuitry executing engager instructions and/or configured to perform operations such as those represented by the flowchart(s) of FIGS. 5 and/or 6. The example engager circuitry 220 generates a prompt that enables the LLM circuitry 230 to determine a next action to be performed in a conversation. In examples disclosed herein the prompt may include instructions to the LLM circuitry 230 for generation of a subsequent message that is to be transmitted to the entity on behalf of the consumer. In some examples, the prompt includes prior messages transmitted to and/or from the entity to enable a next message to be generated.

Various prompt templates may be utilized by the engager circuitry 220 to generate the prompt to be provided to the LLM circuitry 230. Such prompt templates may be stored in, for example, the prompt datastore 203. The prompt templates may later be managed and/or revised to enable improved messages to be generated by the LLM circuitry 230 for being provided to the entity 110.

After the generated prompt is provided to the LLM circuitry 230, the example engager circuitry 220 accesses a message from the LLM circuitry 230 (e.g., via the LLM interface circuitry 225) that includes a response to the prompt. In some examples, the engager circuitry 220 parses the message from the LLM circuitry 230 to extract a message to be transmitted to the entity (and/or other information, such as an indication that no message should be sent at this time).

In some examples, the consumer advocacy system 115 includes means for engaging with an entity. For example, the means for engaging may be implemented by engager circuitry 215. In some examples, the engager circuitry 215 may be instantiated by programmable circuitry such as the example programmable circuitry 1812 of FIG. 18. For instance, the engager circuitry 215 may be instantiated by the example microprocessor 1900 of FIG. 19 executing machine executable instructions such as those implemented by at least blocks 525, 615, 630 of FIGS. 5 and/or 6. In some examples, the engager circuitry 215 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the engager circuitry 215 may be instantiated by any other combination of hardware, software, and/or firmware. For example, the engager circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example large language model interface circuitry 225 of the illustrated example of FIG. 2 interfaces with the large language model 230 to provide a prompt that causes the large language model 230 to generate a response. In some examples, the large language model interface circuitry 225 is instantiated by programmable circuitry executing LLM interface instructions and/or configured to perform operations such as those represented by the flowchart(s) of FIGS. 6 and/or 8.

The example LLM interface circuitry 225 provides prompts at the request of either the engager circuitry 220, the observer circuitry 235, or other components of the consumer advocacy system 115. In some examples, multiple different large language models may be utilized (perhaps being implemented by the same or different LLM circuitry 230). In such examples, the large language model interface circuitry 225 may determine which large language model 230 is to be utilized based on, for example, a type of a prompt to be provided to the large language model, whether the prompt was created by the example engager circuitry 220 or the example observer circuitry 235, etc. Different large language models tend to have different sizes, performance characteristics, and/or costs associated with operating the large language model. For example, a more performant LLM may cost more to operate (e.g., in terms of dollars per transaction, in terms of compute resources such as processor cycles, memory resources, storage resources, etc.), but may be more capable of generating successful responses than another, less performant LLM. Thus, if a task requires generation of a complex response, a more performant LLM may be selected. Conversely, if the task requires generation of a simple response, a less performant LLM may be selected. In some examples, a model may be selected based on a similarity of the task being performed (and/or characteristics thereof) to a task or tasks represented by data used to train a selected model.

In some examples, the consumer advocacy system 115 includes means for interfacing with a large language model. For example, the means for interfacing with a large language model may be implemented by LLM interface circuitry 225. In some examples, the LLM interface circuitry 225 may be instantiated by programmable circuitry such as the example programmable circuitry 1812 of FIG. 18. For instance, the LLM interface circuitry 225 may be instantiated by the example microprocessor 1900 of FIG. 19 executing machine executable instructions such as those implemented by at least blocks 620, 837 of FIGS. 6 and/or 8. In some examples, the LLM interface circuitry 225 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the LLM interface circuitry 225 may be instantiated by any other combination of hardware, software, and/or firmware. For example, the LLM interface circuitry 225 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example LLM circuitry 230 of the illustrated example of FIG. 2 generates a response based on a prompt provided by the large language model interface circuitry 225. In some examples, the large language model 230 is instantiated by programmable circuitry executing large language model instructions and/or configured to perform operations to execute a large language model.

A large language model (LLM) operates by utilizing a neural network architecture known as a Transformer. LLMs are designed to generate human-like text based on a vast amount of data on which the LLM has been trained. In the illustrated example of FIG. 2, the LLM circuitry 230 is illustrated at the edge of the consumer advocacy system 115 to represent that the large language model circuitry 230 may be executed/implemented either locally to the consumer advocacy system 115 or at a computing system remote from the consumer advocacy system 115. For example, large language models may be executed in a cloud setting (e.g., remotely from the consumer advocacy system 115). Remote execution offers some advantages including, for example, that the LLM can be accessed from anywhere, providing scalability and ease of use. Cloud-based models are usually more powerful and/or performant than locally executed models, as cloud-based models typically leverage high-performance hardware and are frequently (e.g., continuously) updated with the latest improvements and fine-tuning. However, cloud-based models may raise concerns about data privacy, latency, and cost, as entities typically pay for the computational resources they consume (e.g., entities pay for use of the cloud-based model).

On the other hand, executing large language models locally provides an entity such as the consumer advocacy system 115 of FIG. 1 with more control over their data, and potentially lower latency for inference. Local execution can also work offline, which is beneficial in scenarios with limited Internet access or where data privacy is important. However, local execution typically requires powerful hardware, significant storage, and regular updates to maintain model performance.

In some examples, the LLM 230 is implemented using a generative pre-trained transformer such as, for example, ChatGPT, GPT-3, GPT-3.5, GPT-4, etc. However, other types of artificial intelligence and/or machine learning structures may additionally or alternatively be used.

In some examples, the consumer advocacy system 115 includes means for executing a large language model. For example, the means for executing may be implemented by LLM circuitry 230. In some examples, the LLM circuitry 230 may be instantiated by programmable circuitry such as the example programmable circuitry 1812 of FIG. 18. For instance, the LLM circuitry 230 may be instantiated by the example microprocessor 1900 of FIG. 19 executing machine executable instructions. In some examples, the LLM circuitry 230 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the LLM circuitry 230 may be instantiated by any other combination of hardware, software, and/or firmware. For example, the LLM circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example observer circuitry 235 of the illustrated example of FIG. 2 monitors conversations carried out between the consumer advocacy system 115 and the entity 110. In some examples, the observer circuitry 235 is instantiated by programmable circuitry executing observer instructions and/or configured to perform operations such as those represented by the flowchart(s) of FIGS. 5 and/or 8.

The example observer circuitry 235 generates one or more prompts that cause the LLM circuitry 230 to identify status variables associated with a conversation being conducted with an entity. Such prompts may include, for example, a summary of the conversation, a history of the conversation (e.g., in a partially summarized format, in a non-summarized format, etc.), instructions on various status variables that are to be identified (e.g., “please determine whether a tracking number has been provided”). In examples disclosed herein, the prompts generated by the observer circuitry 235 include formatting instructions that cause the LLM circuitry 230 to provide a response in a particular format. For example, the prompt may request that the LLM circuitry 230 provide the status variables back to the observer circuitry 235 utilizing JavaScript object notation (JSON) markup. However, any other format for conveying variables may additionally or alternatively be used including, for example, a comma separated value (CSV) format, an extensible markup language (XML) format, an initialization (INI) format, a text format, etc.

In some examples, the consumer advocacy system 115 includes means for observing a conversation. For example, the means for observing may be implemented by observer circuitry 235. In some examples, the observer circuitry 235 may be instantiated by programmable circuitry such as the example programmable circuitry 1812 of FIG. 18. For instance, the observer circuitry 235 may be instantiated by the example microprocessor 1900 of FIG. 19 executing machine executable instructions such as those implemented by at least blocks 530, 540, 835, 840 of FIGS. 5 and/or 8. In some examples, the observer circuitry 235 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the observer circuitry 235 may be instantiated by any other combination of hardware, software, and/or firmware. For example, the observer circuitry 235 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example entity interface circuitry 240 of the illustrated example of FIG. 2 enables interaction with the entity 110 of FIG. 1. In some examples, the entity interface circuitry 240 communicates via a web interface (e.g., a chat prompt hosted on a website of the entity 110). However, any other technology and/or techniques may be used for interfacing with the entity 110 including, for example, email communications, form filling on a web page, telephone calls, short message service (SMS) communications, etc.

In some examples, the entity interface circuitry 240 is implemented using a web browser (e.g., a headless web-browser, an automated web browser) and/or other network-enabled communication instructions executed at the consumer advocacy system 115 (e.g., at a server) that are instrumented to closely resemble communications that would have originated form a consumer device. In such examples, the communication with the entity 110 might not utilize user credentials (e.g., a log-in) and may, instead, operate solely on the name, address, phone number, account number, order information, etc. as provided by a consumer (either as part of the consumer advocacy request or as preferences/configuration information stored in the consumer information datastore 117). That is, a generic chat session may be opened between the consumer advocacy system 115 and the entity 110 (without providing consumer credentials), and may the consumer advocacy system 115 may then provide consumer-identifying information via the chat session. Additionally or alternatively, consumer credentials for an entity may be provided and be used for establishing the communication between the consumer advocacy system 115 and the entity. Such credentials may include a username and password, a two factor authentication (2FA) token, open authorization (OAuth) information, session tokens, etc.

As noted above, the example consumer advocacy system 115 may be implemented at a server and/or cloud computing system. In this manner, communications from the consumer advocacy system 115 may appear to originate from a same device/Internet protocol (IP) address, even though multiple (different) consumers are represented by that device. To address various IP-blocking techniques, requests and/or communications sessions may be routed through proxies, virtual private networks (VPNs), etc. to enable the communications to more closely resemble communications from a consumer device.

Moreover, in some examples, components of the example consumer advocacy system 115 may be implemented at a user device (e.g., a mobile device of the consumer). For example, the entity interface circuitry 240 may be implemented, in part, at a consumer device (e.g., as a plug-in, that enables automation of chat sessions with an entity). Implementing the entity interface circuitry 240 at the consumer device avoids potential issues with IP-blocking techniques, as the communications and/or chat sessions do, in-fact, originate from a consumer device. Implementing the entity interface circuitry 240 (or portions thereof) to be executed at a consumer device presents additional challenges such as compatibility, user acceptance, communication signal coverage, etc.; but also enables additional authentication techniques to be more easily used, such as re-utilization of session tokens that may be stored in a browser of the consumer device. Additional prompts and/or templates may be utilized if, for example, it were anticipated that signal coverage would likely drop momentarily, thereby causing the transmission of a message similar to “I am about to lose signal coverage, I will re-connect momentarily.”

In some examples, the entity interface circuitry 240 is instantiated by programmable circuitry executing entity interface instructions and/or configured to perform operations such as those represented by the flowchart(s) of FIG. 5. In some examples, the entity interface circuitry 240 enables communications with the entity to perform pre-conversation tasks including, for example, navigating through a web site of the entity 110, filling out forms at a web site of the entity 110, navigating through telephonic prompts of a voice system of the entity 110, etc. Such pre-conversation activity enables the consumer advocacy system 115 to establish a conversation with the entity 110.

In some examples, the consumer advocacy system 115 includes means for interfacing with an entity. For example, the means for interfacing may be implemented by entity interface circuitry 240. In some examples, the entity interface circuitry 240 may be instantiated by programmable circuitry such as the example programmable circuitry 1812 of FIG. 18. For instance, the entity interface circuitry 240 may be instantiated by the example microprocessor 1900 of FIG. 19 executing machine executable instructions such as those implemented by at least blocks 520, 535, 540, 555 of FIG. 5. In some examples, the entity interface circuitry 240 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the entity interface circuitry 240 may be instantiated by any other combination of hardware, software, and/or firmware. For example, the entity interface circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

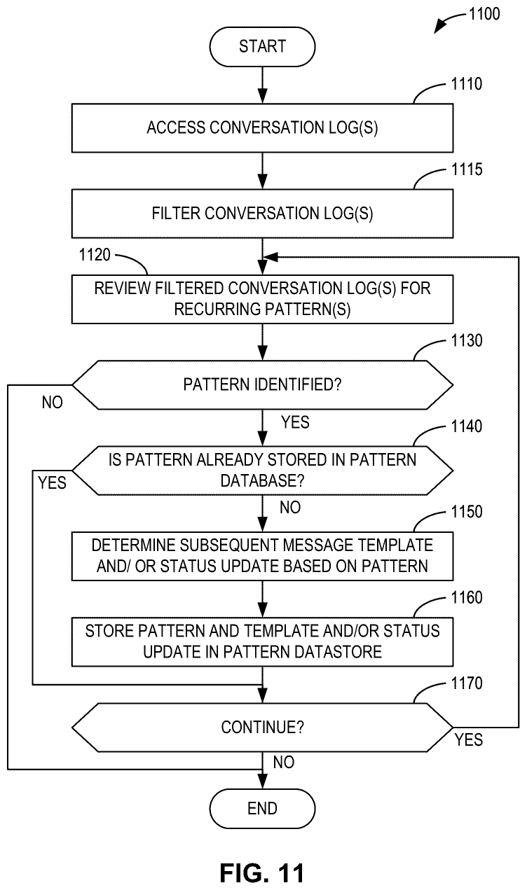

The example conversation reviewer circuitry 245 of the illustrated example of FIG. 2 reviews conversations conducted between the consumer advocacy system 115 and various entities 110 to evaluate an outcome of the conversation and, in some examples, attempt to identify patterns and/or issues in those conversations. In some examples, the conversation reviewer circuitry 245 is instantiated by programmable circuitry executing conversation reviewer instructions and/or configured to perform operations such as those represented by the flowchart(s) of FIGS. 5, 11, and/or 13.

At the termination of engagement with an entity (as a conversation is being completed), the example conversation reviewer circuitry 245 reviews status variables representing the conversation to determine whether the objective of the conversation has been achieved. In some examples, the example conversation reviewer circuitry 245 records any next tasks that are to be performed as a result of the conversation. Such next tasks may include entity next tasks and/or consumer next tasks.

After conversations have been conducted, the conversation reviewer circuitry 245 may review those conversations to attempt to identify patterns, thereby enabling improvements to be made in prompt templates, status update instructions, message templates, etc. In some examples, issues in those conversations may also be identified to enable administrators to be alerted of potential problems encountered when communicating with an entity.

In some examples, the consumer advocacy system 115 includes means for reviewing a conversation. For example, the means for reviewing a conversation may be implemented by conversation reviewer circuitry 245. In some examples, the conversation reviewer circuitry 245 may be instantiated by programmable circuitry such as the example programmable circuitry 1812 of FIG. 18. For instance, the conversation reviewer circuitry 245 may be instantiated by the example microprocessor 1900 of FIG. 19 executing machine executable instructions such as those implemented by at least blocks 1110, 1115, 1120, 1130, 1140, 1150, 1160, 1170, 1310, 1315, 1320, 1330, 1340, 1350, 1360 of FIGS. 11, and/or 13. In some examples, the conversation reviewer circuitry 245 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the conversation reviewer circuitry 245 may be instantiated by any other combination of hardware, software, and/or firmware. For example, the conversation reviewer circuitry 245 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example fine-tuning circuitry 250 the illustrated example of FIG. 2 performs and/or causes performance of additional fine-tuning of the LLM executed by the LLM circuitry 230. In some examples, the fine-tuning circuitry 250 is instantiated by programmable circuitry executing fine-tuning instructions.

Beyond initial training of a model to be used by the LLM circuitry 230, further training, sometimes referred to as fine-tuning may be performed. Fine-tuning involves taking an existing, pre-trained model, and further training the model on a smaller, task-specific dataset. An example goal of this process is to make the model adapt to the nuances and requirements of the target task (e.g., interacting with an entity on behalf of a consumer) while retaining the valuable knowledge and representations the model has acquired during the initial pre-trained training phase.

In other words, the pre-trained model typically serves as a starting point, providing a foundation of generalized knowledge that spans across various domains. For instance, in natural language processing, pre-trained language models (e.g., GPT-3) have already learned grammar, syntax, and world knowledge from extensive text corpora. Fine-tuning such pre-trained models builds upon this foundation by adjusting the model's weights and parameters based on the new, task-specific data.

To accomplish fine-tuning, a dataset that is specific to the task to be performed is used. This dataset contains examples or samples relevant to the task, often with associated labels or annotations. Thus, examples disclosed herein may utilize a model that has been fine-tuned using prior conversations with an entity and/or information about such conversations. During fine-tuning, the model is trained to recognize patterns and features in the task-specific data, aligning the internal representations within the model to the requirements of the target task. Fine-tuning may involve not only updating the model's weights but also adjusting hyperparameters like learning rates, batch sizes, and regularization techniques to ensure that the model converges effectively on the new task. Depending on the complexity of the task, architectural changes may also be made to the model, such as freezing certain layers, adding task-specific layers, or modifying the model structure. Fine-tuning is a powerful technique used in various domains, including natural language processing, computer vision, recommendation systems, and more, as it enables the adaptation of pre-trained models to solve specific real-world problems efficiently and effectively.

In some examples, different models may be fine-tuned for performing particular tasks and/or curated on particular data sets. For example, a first model might be trained to interact with an agent for returns of clothing items to retailers, whereas a second model might be trained to interact with an agent for returns of non-clothing items to retailers. In this manner, various prior conversations for clothing items vs. non-clothing items may be used to fine-tune the model(s) from which the LLM interface circuitry 225 may select. History with specific entities might call out specific wordings, phrases, styles of communication, etc. that are beneficial or create issues (e.g., have varying effectiveness) and may be used as part of the fine-tuning. Thus, example models may be fine-tuned on many different combinations of information including, for example, actions to be performed (e.g., returns, warranty claims, subscription cancellations, etc.), entity knowledge (e.g., specific entities, policies, item types, processes, etc.), geographic locations, consumer preferences, etc. In general, models that are enabled to communicate more effectively (e.g., by having been trained on data sets specific to a particular use-case), will better support a consumer's interests.

Fine-tuning of models may be triggered and/or initiated in many different manners. For example, fine-tuning may be initiated periodically (e.g., weekly, monthly, quarterly, etc.), to enable the example consumer advocacy system 115 to adapt to changing conversations over time. Additionally or alternatively, fine-tuning may be initiated a-periodically to, for example, allow the consumer advocacy system 115 to react to detected issues, new patterns, new prompt templates, etc. For example, in connection with FIG. 11, fine-tuning may be initiated in response to detection of a new pattern to be stored for use by the standard handler circuitry 215. In some examples, fine-tuning may be initiated in response to detection of new policy information.

In some examples, the consumer advocacy system 115 includes means for fine-tuning a model. For example, the means for fine-tuning a model may be implemented by fine-tuning circuitry 250. In some examples, the fine-tuning circuitry 250 may be instantiated by programmable circuitry such as the example programmable circuitry 1812 of FIG. 18. For instance, the fine-tuning circuitry 250 may be instantiated by the example microprocessor 1900 of FIG. 19 executing machine executable instructions. In some examples, the fine-tuning circuitry 250 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the fine-tuning circuitry 250 may be instantiated by any other combination of hardware, software, and/or firmware. For example, the fine-tuning circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

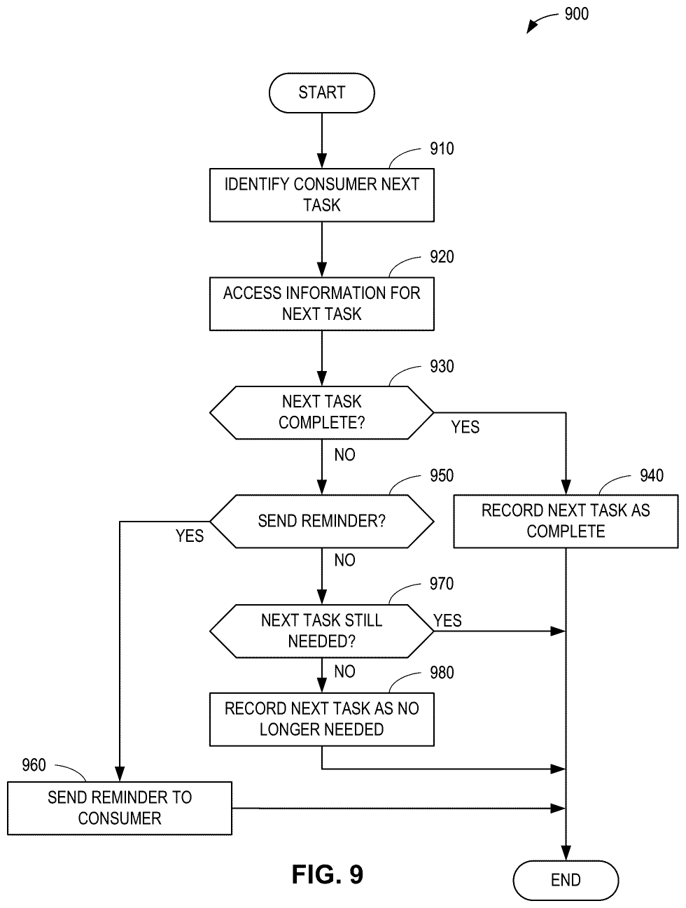

The example third-party interface circuitry 255 of the illustrated example of FIG. 2 enables the consumer advocacy system 115 to communicate with third parties (e.g., parties other than the consumer 105 and/or the entity 110). In some examples, the third-party interface circuitry 255 is instantiated by programmable circuitry executing third-party interface instructions and/or configured to perform operations such as those represented by the flowchart(s) of FIGS. 9 and/or 10.

In some examples, information regarding the completion of the action (e.g., a consumer next task, an entity next task) is stored at third-party sites such as, for example, an email server, a courier tracking system, a web site, etc. The example third-party interface circuitry 255 accesses this information from the third-party site to enable identification of whether a next task has been completed. For example, the third-party interface circuitry 255 may access a courier tracking system using a tracking number that is to be used for return of the package to determine whether the consumer has dropped off the package at a drop-off location of the courier (e.g., has the courier received the package?). In this manner, the example third-party interface circuitry 255 may be implemented by a web browser (e.g., an automated and/or headless web browser), or other approach to communicating with a third-party site.

In some examples, the third-party interface circuitry 255 interacts with an email server based on credentials or other authentication systems enabled by the consumer. In some examples, tracking receipts and/or other information may be provided to the consumer by the entity 110 via email. The example third-party interface circuitry 255 enables the consumer advocacy system to access such information.

In some examples, the consumer advocacy system 115 includes means for interfacing with a third party. For example, the means for interfacing with a third party may be implemented by third-party interface circuitry 255. In some examples, the third-party interface circuitry 255 may be instantiated by programmable circuitry such as the example programmable circuitry 1812 of FIG. 18. For instance, the third-party interface circuitry 255 may be instantiated by the example microprocessor 1900 of FIG. 19 executing machine executable instructions such as those implemented by at least blocks 920, 1020 of FIGS. 9 and/or 10. In some examples, the third-party interface circuitry 255 may be instantiated by hardware logic circuitry, which may be implemented by an ASIC, XPU, or the FPGA circuitry 2000 of FIG. 20 configured and/or structured to perform operations corresponding to the machine readable instructions. Additionally or alternatively, the third-party interface circuitry 255 may be instantiated by any other combination of hardware, software, and/or firmware. For example, the third-party interface circuitry 255 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

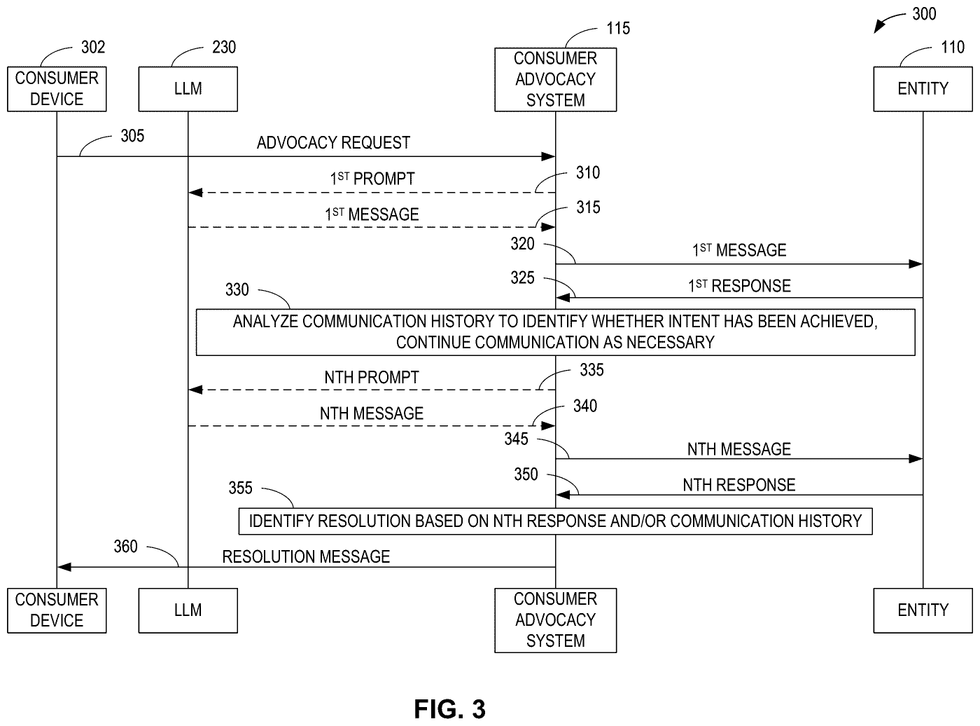

FIG. 3 is a communication diagram 300 representing example communications between a consumer device 302, the consumer advocacy system 115 of FIG. 1, the LLM circuitry 230 of FIG. 2, and the entity 110 of FIG. 1. The example consumer device 302 represents any device (e.g., a mobile device, a desktop computer, a smart assistant device, etc.) that is operated by a consumer. The example communication diagram begins when the example consumer device 302 transmits a consumer advocacy request 305 to the consumer advocacy system 115. In some examples, the consumer advocacy request 305 may be a request to return an item.

In some examples, the consumer advocacy request represents a request to return a previously purchased item. However, it should be understood that any other type of consumer advocacy request may additionally or alternatively be utilized. The consumer advocacy system 115 provides a first prompt 310 to the LLM circuitry 230 to request generation of a first message that is to be transmitted to the entity 110. This prompt may instruct the LLM circuitry 230 to perform a particular task (e.g., play a role) in communicating with the entity on behalf of a consumer. Various instructions may be provided to the LLM circuitry 230 by way of the prompt 310 including, for example, instructions related to the context, role-playing instructions, process and/or policy instructions, conversation details, instructions on how to respond to particular questions, unacceptable response guidance, examples, and/or other communication requests.

Context instructions define the objective, industry, and/or specific situation (e.g., action) in which the conversation with the entity 110 is to occur. In some examples, context instructions may include consumer preference information. In some examples, this also includes the naming of particular terms relevant to the industry, action, objective, etc.

Role-playing instructions indicate to the LLM circuitry 230 a role that is to be played by the LLM circuitry 230 in participating in the conversation. This may include, for example, “who” the LLM circuitry 230 is to act as, as well as a requested level of expertise, a persona, a style, languages to be used, etc. For example, the role-playing instruction may instruct the LLM circuitry 230 that they are to act on behalf of a consumer named “John.”

Process and/or policy instructions define the policies, processes, and/or procedures of an entity. As an example, this information may include whether an entity will accept a return of an item, a time period in which the entity will accept a return of the item, how refunds for such returns are issued, etc. In some examples, this information originates from prior conversations with the entity, which may include conversations with the entity on behalf of other consumers. In some examples, this also includes the naming of particular terms relevant to the entity (e.g., entity-specific terminology such as “return good authorization” being “RGA”).

In some examples, the instructions may identify backup plans. For example, such backup plans may indicate acceptable outcomes if, for example, the interaction with the entity does not go according to the consumer's initial request. In this manner, the backup plans represent alternate acceptable objectives. In some examples, it may be acceptable to receive a denial/refusal of a return, as such denial/refusal provides information for subsequent conversations. Thus, there are multiple different ways a conversation may be identified as complete including, for example, success (initial request being fulfilled), denial (initial request being denied), information gain (learned additional information for subsequent conversations), backup plan utilized (pre-understood acceptable outcome, but different form initial request). In some examples, additional guidance on when to give up and, perhaps, retry in a subsequent conversation may be provided. Such additional guidance is useful in situations when conversing with a difficult agent.

Conversation details identify particular reference numbers, dates, times, locations, etc. that may be referenced in the conversation. This information may originate from the advocacy request, details thereof, from third party sources (e.g., from prior conversations with the entity on behalf of the consumer, email servers, instant messaging systems, SMS systems, etc.), and/or from user preferences/options.

Instructions on how to respond to particular questions may be included to identify specific topics/things that may be asked during the conversation and how best to answer. This can range from requesting that the LLM circuitry 230 never agree to answer a survey, to more subtle guidance to be brief when discussing some specific matter.

Unacceptable response guidance may be utilized to indicate particular information that is not to be disclosed. Including such guidance to the LLM circuitry 230 is important. Such guidance places guard rails on the conversation to limit the ability of the LLM circuitry 230 to make things up. Moreover, there may be information that the consumer does not desire to be disclosed, such that not discussing the information/item is actually the most appropriate approach/response. Examples include simply not discussing the weather, not disclosing why the consumer wishes to cancel, etc.

In some examples, example messages may be provided to the LLM circuitry 230 to, for example, provide examples of the desired responses or interactions to give more nuanced guidance. Other information including, for example, an attitude, a level of verbosity, communication/language style preferences, etc. may additionally or alternatively be included in the prompt 310.

The prompt 310 can also include references to information to support the consumer's case. These may be from the policy information stored in association with the entity, and/or may come from previous correspondence with the company including emails, chats, contracts, etc. For example, the prompt 310 may include information about a prior conversation where the entity 110 identified a particular piece of information.

In some examples, the prompt 310 includes information from other sources. In some examples, this may include information about public sites with ratings, feedback (e.g., reviews), a brand, a manufacturer, item, industry policies, best practices, guidelines, notifications of recalls, warranty issues, other customer complaints, news of unfair practices, unethical sourcing behaviors, health risks, choking hazards, etc.

Based on the first prompt 310, the example LLM circuitry 230 creates a first response message 315, which is provided to the consumer advocacy system. In this manner, the consumer advocacy system 115 obtains a first message from large language model based on a return request provided by the consumer. In some examples, the return request is associated with a previously purchased product that is to be returned to an entity.

The consumer advocacy system 115 may perform processing of the message to, for example, transform the message into a format for sending to the entity 110, analyze the message to confirm it is appropriate, etc. The example consumer advocacy system 115 causes transmission of the message 320 to the entity 110. This first message 320 typically will establish the intent of the consumer to the entity 110 including, for example, to request authorization of the return of the previously purchased product. The entity responds to the first message 320 with a first response 325. The example consumer advocacy system 115 analyzes the communication history (e.g., the messages exchanged between the consumer advocacy system 115 and the entity 110) to determine whether the intent of the consumer advocacy request has been achieved. (Block 330).

A subsequent prompt 335 is provided to the LLM 230 to cause generation of message 340. This subsequent prompt may include, for example, the message 320, the response 325, or even a conversation history of the message exchanged between the consumer advocacy system 115 and the entity 110. In some examples, the conversation history is summarized prior to providing the conversation history to the LLM circuitry 230. As a conversation grows with respect to its token count and/or text length, a computational expense of analyzing the conversation increases. This can be reduced by summarizing (e.g., utilizing an LLM) the conversation status and/or context up to the present and uses this summary in the prompt 335 going forward. In other words, sections of the conversation can be collapsed into a short amount of text, to allow the conversation to continue more efficiently. In some examples, use of the summary may be introduced after a threshold number of words, tokens, statements, have been made in the conversation.

The message 340 is then analyzed/transformed and then provided to the entity 110. In this manner, the consumer advocacy system 115 causes transmission of the message 345 to the entity 110 to continue the request to return the previously purchased product. The consumer advocacy system 115 then accesses a subsequent response 350 from the entity 110, and then analyzes whether to continue the conversation. The example process of providing a prompt 335 to the LLM circuitry 230, and receiving a response message 340, which is then relayed 345 to the entity 110, and then awaiting a response 350, is continued until the consumer advocacy system 115 determines that the conversation can be concluded. The conversation may be concluded based on the intent of the consumer advocacy request being achieved (e.g., a complete success), being partially achieved (e.g., a partial success), being informed that the request cannot be fulfilled, etc. In some examples, a failure to achieve the initial desired objective, but achievement of a different equally acceptable objective, may be considered a success (e.g., a divergent success). For example, if a consumer had desired to return a food item, but the entity (e.g., by policy) will not take the food item back, but instead credit the consumer with a refund (e.g., without receiving the item), this may be an acceptable outcome for the consumer (e.g., they are credited and may dispose of the food item).

The example consumer advocacy system 115 identifies a resolution of the communication history between the consumer advocacy system 115 and the entity 110 (Block 355), and causes transmission of a resolution message 360 to the consumer device 302. This resolution message informs the consumer of the outcome (e.g., the resolution) of the conversation with the entity 110. In some examples, the resolution message identifies next tasks that are to be taken by the consumer and/or entity. In some examples, the consumer next task may instruct the consumer to deliver an item to a shipping drop-off location of a courier service that has been arranged to transport the item to a location of the entity, may instruct the consumer to ship the item (e.g., a previously purchased product) to a destination. However, any other drop-off location may additionally or alternatively be used (e.g., a drop-off location not associated with a courier). As used herein, drop-off locations may include, for example, a courier location, a mailbox location, a locker location, shipping entity storefront, etc.

In some examples, the resolution message informs the consumer that they are allowed to discard the previously purchased product. In some examples, the resolution message identifies an amount of money that is to be returned to the customer (e.g., upon receipt of the previously purchased product at the entity 110). In some examples, this amount of money is based on a return fee (e.g., a fee charged by the entity such as, for example, a re-stocking fee, a shipping and handling fee, etc.). In some examples, the resolution message includes an indication of a date by which a return activity is to occur.

In some examples, the resolution message 360 may include a copy of the conversation carried out between the consumer advocacy system 115 and the entity 110. Additionally or alternatively, the conversation may be summarized, and the summary of the conversation may be provided as part of the resolution message 360.

While in the illustrated example of FIG. 3, each message to the entity 110 from the consumer advocacy system 115 is preceded by a prompt and reply to/from the LLM 230, in some examples, messages may be sent to the entity 110 by the consumer advocacy system 115 without having to interact with the LLM 230. In other words, the prompts and replies thereto (as represented by dotted lines) may be optional. For example, the standard handler circuitry 215 may be utilized to identify a particular message that should be sent at a given point in a conversation. For example, the initial message (e.g., message 320) from the consumer advocacy system 115 to the entity 110 may be generated by the standard handler circuitry 215 and convey an intent of the conversation to the entity 110 (e.g., “I would like to return an item”). Moreover, the standard handler circuitry 215 may be utilized at any point during the conversation to enable generation of a message to be sent to the entity 110 without use of the LLM circuitry 230.

While an example manner of implementing the consumer advocacy system 115 of FIG. 1 is illustrated in FIG. 2, one or more of the elements, processes, and/or devices illustrated in FIG. 2 may be combined, divided, re-arranged, omitted, eliminated, and/or implemented in any other way. Further, the example consumer interface circuitry 205, the example skipper circuitry 210, the example advocacy controller circuitry 212, the example standard handler circuitry 215, the example engager circuitry 220, the example LLM interface circuitry 225, the example LLM circuitry 230, the example observer circuitry 235, the example entity interface circuitry 240, the example conversation reviewer circuitry 245, the example fine-tuning circuitry 250, the example third-party interface circuitry 255, and/or, more generally, the example consumer advocacy system 115 of FIG. 2, may be implemented by hardware alone or by hardware in combination with software and/or firmware. Thus, for example, any of the example consumer interface circuitry 205, the example skipper circuitry 210, the example advocacy controller circuitry 212, the example standard handler circuitry 215, the example engager circuitry 220, the example LLM interface circuitry 225, the example LLM circuitry 230, the example observer circuitry 235, the example entity interface circuitry 240, the example conversation reviewer circuitry 245, the example fine-tuning circuitry 250, the example third-party interface circuitry 255, and/or, more generally, the example consumer advocacy system 115, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example consumer advocacy system 115 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the consumer advocacy system 115 of FIG. 2 and/or representative of example operations which may be performed by programmable circuitry to implement and/or instantiate the consumer advocacy system 115 of FIG. 2, are shown in FIGS. 4-14. The machine readable instructions may be one or more executable programs or portion(s) of one or more executable programs for execution by programmable circuitry such as the programmable circuitry 1812 shown in the example processor platform 1800 discussed below in connection with FIG. 18 and/or may be one or more function(s) or portion(s) of functions to be performed by the example programmable circuitry (e.g., an FPGA) discussed below in connection with FIGS. 19 and/or 20. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-14, many other methods of implementing the example consumer advocacy system 115 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine readable instructions and/or the corresponding program(s) can be executed in whole or in part. Thus, machine readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-14 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart 400 representative of example machine readable instructions and/or example operations that may be executed, instantiated, and/or performed by example programmable circuitry to implement the consumer advocacy system 115 of FIG. 2 to handle a request for coordination of a return from a consumer. The example process 400 of the illustrated example of FIG. 4 begins when the example consumer interface circuitry 205 accesses a return request from a consumer. (Block 405). In some examples, the return request may be in reference to a previously purchased product. The previously purchased product may be identified based on analysis of an image of a receipt captured by the consumer, analysis of an email communication from the entity to the consumer, a purchase history of an account of the consumer at an entity site, etc.

The example skipper circuitry 210 analyzes the request to determine whether to initiate communication with the entity on behalf of the consumer. (Block 410). To make such a determination, the example skipper circuitry 210 reviews the return request in connection with information about the entity, information about consumer, etc. to determine whether the requested action return is a preferred (e.g., most economical) option for the consumer. In some examples, it may be more economical for the consumer to pursue an alternative approach (e.g., selling an item) rather than following through with the requested action (e.g., returning an item). For example, if an original retailer were to charge a 20% restocking fee (or a flat fee, a shipping and handling fee, etc.), and the item could easily be sold at a third-vendor at the whole retail price, it would be more economical for the consumer to pursue the alternate approach of selling the item using the third-party vendor, rather than returning the item to the original retailer. In some examples, a request to coordinate a return that is unlikely to be approved may also result in the alternative approach being followed. For example, if an item to be returned was purchased more than ninety days ago (so is no longer eligible for return with a given entity), donating the item may be a more advantageous alternative approach to pursue.

If the example skipper circuitry 210 determines that an alternative approach is to be followed (e.g., block 410 returns a result of “ALTERNATIVE APPROACH”), the example skipper circuitry 210 causes the consumer interface circuitry 205 to transmit a message to instruct the consumer to follow the alternative approach (e.g., to donate the item, to sell the item using a third-party platform, to contact the manufacturer, etc.). In some examples, the consumer advocacy system 15 may facilitate execution of the alternative approach. That is, the example consumer advocacy system 115 may communicate with the third-party platform (e.g., an electronic marketplace) on behalf of the consumer to facilitate sale of the item.

In some examples, options for alternative approaches may be provided to the consumer to enable the consumer to choose their preferred alternative approach to returning an item.

In some examples, an alternative approach may involve instructing the consumer to simply ship the item back to the entity (e.g., using a return label that was included in the initial packaging of the item, may involve instructing a consumer as to how to safely ship/dispose of a battery, etc.). In some examples, an entity will process a return simply by receiving the item back.

As an additional example, in some cases, the consumer may desire to return an item that the entity will not take back. For example, some online retailers have policies that do not allow for the return of food items. In such cases, the example skipper circuitry 210 may instruct the consumer to follow an alternative approach such as, for example, donating the food item to a food pantry (e.g., assuming the item is still consumable).

The example skipper circuitry 210 causes the entity interface circuitry 240 to inform the entity of the consumer pursuing the alternate approach via the entity interface circuitry 240. (Block 418). In some examples, it may be advantageous for the entity to be informed that the consumer would have returned an item, but chose to follow an alternative approach.

In some examples, if the likelihood that an entity will accept a return of an item does not meet or exceed a threshold, the skipper circuitry 210 may determine that the consumer advocacy system 115 should communicate with the entity to advocate for the consumer. If the example skipper circuitry 210 determines that the example consumer advocacy system 115 should communicate with the entity to attempt to advocate for the consumer (e.g., block 410 returns a result of “COMMUNICATE WITH ENTITY”), the example skipper circuitry 210 next determines whether a number of communication attempts to the entity on behalf of the consumer (i.e., for the return request in question) meets or exceeds a threshold number of attempts. (Block 420). In some examples, additional delays may be added to, for example, enable communication attempts to the entity based on business hours of the entity.

Ideally, the example consumer advocacy system 115 should only need to communicate with the entity on behalf of the consumer once to coordinate return of an item and/or perform other advocacy for the consumer. However, in some examples, the communication with the entity may fail to achieve a desired outcome. For example, when communicating with an entity to return item, a customer service agent of the entity may disconnect the communication session, may indicate that they are unwilling to help the customer, etc. If the number of communication attempts meets or exceeds the threshold (e.g., block 420 returns results of YES), the example skipper circuitry 210 alerts an administrator of the consumer advocacy system 115. (Block 430). If, for example, the number of communication attempts meets or exceeds the threshold, this indicates that a potential repeated failure may have occurred. An administrator may then intervene and take corrective action. Such intervention may include contacting the entity (e.g., manually) to advocate for the consumer, initiating an update of a record of a policy for the entity, initiating an update of a message template, etc.

If the number of communication attempts does not meet or exceed the threshold (e.g., block 420 returns a result of NO), the example consumer advocacy system 115 communicates with the entity on behalf of the consumer to advocate for the consumer. (Block 450). An example approach for communicating with the entity on behalf of the consumer is disclosed in further detail in connection with FIG. 5, below.

The example process 400 of the illustrated example of FIG. 4 then terminates. However, the example process 400 may be repeated periodically and/or a-periodically to, for example, process a return request on behalf of the consumer, re-attempt a previously failed attempt to achieve an objective, etc. In some examples, a collection of return requests may be represented by a queue and/or other data structure identifying tasks to be performed. Such a queue and/or other data structure may be stored in the consumer information datastore 117, and the presence of tasks in the queue may cause the execution of the example process 400 of FIG. 4. In some examples, communication with the entity on behalf of the consumer may fail, resulting in the return request being placed back into the queue for later processing.

FIG. 5 is a flowchart representative of example machine readable instructions and/or example operations that may be executed, instantiated, and/or performed by example programmable circuitry to implement the consumer advocacy system 115 of FIG. 2 to communicate with an entity on behalf of a consumer.

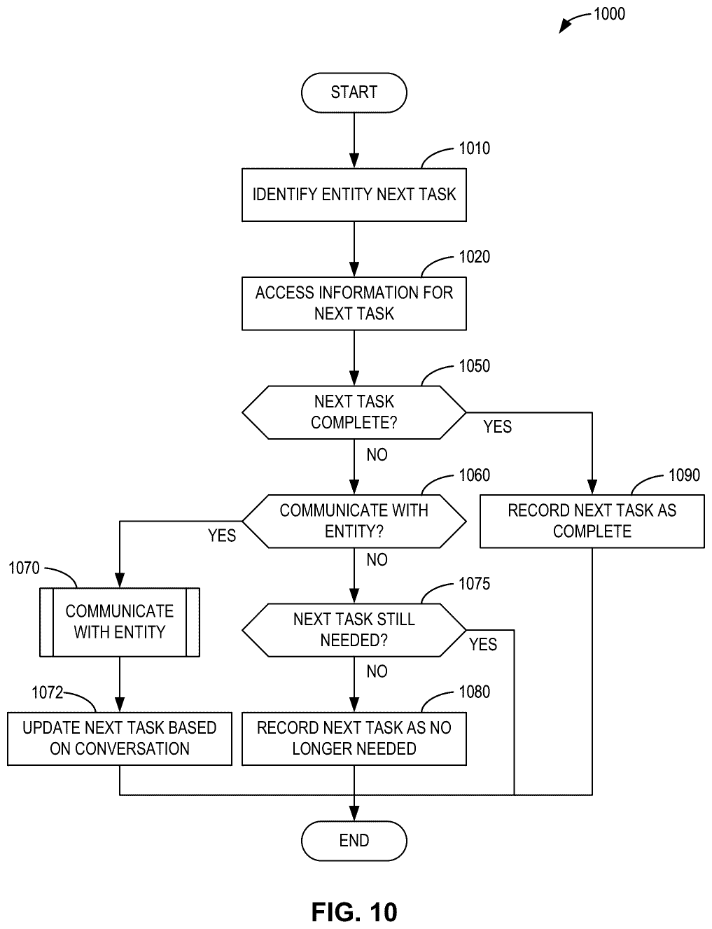

The example process 500 of the illustrated example of FIG. 5 represents the example consumer advocacy system 115 communicating with an entity on behalf of the consumer to achieve an objective. The example process 500 of the illustrated example of FIG. 5 begins when the example advocacy controller circuitry 212 determines an intent (e.g., an objective) to be achieved by way of the conversation. (Block 510). Such an intent and/or objective may be identified based on a request provided by the consumer, and/or may be the result of an entity next task (e.g., described below in connection with FIG. 10). An entity next task represents an action that is to be performed by an entity. In some examples, the consumer advocacy system 115 may re-contact the entity to inquire about the status of such a next task.

The example advocacy controller circuitry 212 identifies order information. (Block 512). In examples disclosed herein, the example order information represents information regarding the item to be returned and/or other information pertaining to the individual situation (e.g., the consumer request) that may be used when communicating with the entity.

The example advocacy controller circuitry 212 identifies consumer preferences. (Block 514). The consumer preferences identify the available options for outcomes that will be acceptable for the consumer. For example, the consumer may have a preference to drop off items to be returned at a particular location, a consumer may have a preference that an item be picked up from their current location, etc. In this manner, consumer preferences may identify any sort of detail regarding the objective to be achieved via conversation.

The example advocacy controller circuitry 212 identifies entity policies. (Block 516). Such policies may be stored in the example entity information datastore 201. The example entity policies create an understanding of outcomes that are achievable by the consumer advocacy system 115. For example, policies may dictate that certain types of items may not be returned to a particular entity, may dictate that returns may only occur within a threshold number of days since delivery of an item, etc.

Having determined the objective of the conversation (e.g., return an item), details about the objective (e.g., order number), consumer preferences (e.g., please credit my initial payment method), and entity policies (e.g., returns are accepted within 14 days from purchase), the advocacy controller circuitry 212 then initiates communication with the entity. The example entity interface circuitry 240 establishes a connection with the entity. (Block 520). The example connection is made with the entity by opening a chat session via a website of the entity. However, any other approach to establishing a connection with an entity may additionally or alternatively be used. For example, an audio connection may be made to the entity (e.g., a telephone call), web sockets may be used to enable a conversation with the entity, etc., While the above examples represent communication modes that enable contemporaneous conversations, other communication modes may additionally or alternatively be used. For example, email messages may be exchanged with the entity on behalf of the consumer.

Upon establishing the connection with the entity, the example engager circuitry 220 and/or the example standard handler 215 determine a next action to be performed in the conversation. (Block 525). In an initial iteration, this “next action” may represent a first action. An example approach for determining the next action to be performed is disclosed in further detail in connection with FIG. 6. In short, the example engager circuitry 220 and/or the example standard handler circuitry 215 determine the next message to be sent to the entity via the connection or, alternatively, whether no additional action should be taken at this time. Ordinarily, when beginning a conversation with an entity, the first action that will be determined will be a message conveying the intent and/or objective of the conversation. For example, a message identifying an order number and an item to be returned may be determined to be the first action (e.g., “I would like to return this item from order number 123456”).

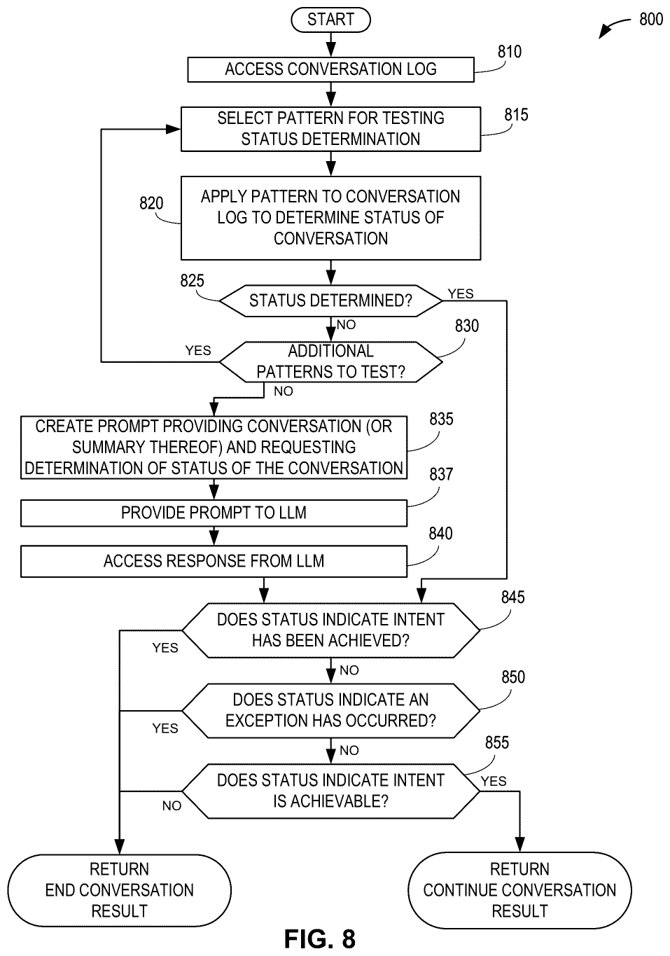

The example observer circuitry 235 and/or the example standard handler circuitry 215 determines a status of the conversation, and whether the conversation should be continued or ended. Block 530. An example approach to determining the status of the conversation is described further below in connection with FIG. 8. The example status may be represented by one or more status variables that collectively represent the status of the conversation. In some examples, the one or more status variables are represented in a single object or other data structure. Such variables may include, for example, whether the interaction is complete, whether the intent of the conversation has been achieved, was the most recent interaction from the agent a question, must an item in question be returned to obtain a refund, has a refund already been issued, is a refund amount known, has the return of the item in question been approved by the entity, has a return label been sent, the location at which the item needs to be dropped off (e.g., a courier location, a mailbox location, a locker location, shipping entity storefront, etc.) known, etc. Moreover, in some examples, the status variables used may be dependent upon the industry, context, objective, entity, etc. For example, during a return of a product, the variable IS_SHIPPING_LABEL_SENT might be used to indicate whether a shipping label has been sent to the consumer. In contrast, such a status variable might not be used during negotiation of a reduced rate for a subscription service. Instead, a different variable might be used which would not have been applicable to the return of an item, such as NEW_RATE to indicate a newly negotiated rate.

In addition, the status variables may include an indication of whether the conversation should be continued. Sometimes, the indication of whether the conversation should be continued is represented as a separate variable from the remainder of the status variables.

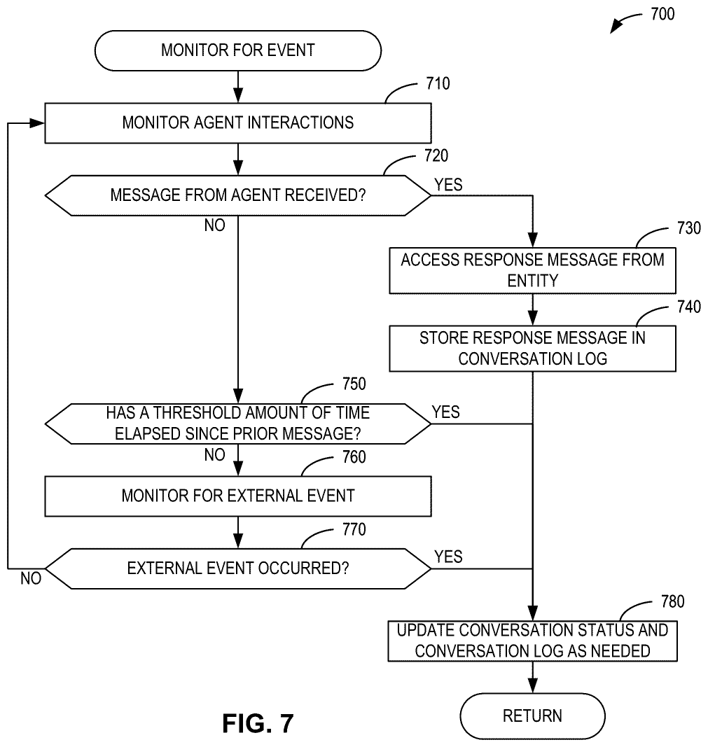

If the example observer circuitry 235 and/or the example standard handler circuitry 215 determine that the conversation should be continued (e.g., block 530 returns a result of “CONTINUE CONVERSATION”), the example entity interface circuitry 240 determines whether there is a message to be sent. (Block 535). In some examples, the engager circuitry 220 and/or the example standard handler circuitry 215, at block 525, may have determined that no message is to be sent at this point in the conversation. If a message is to be sent (e.g., block 535 returns a result of YES), the example entity interface circuitry 240 transmits the message to the entity. (Block 540). If no message is to be sent (e.g., block 535 returns result NO), the example consumer advocacy system 115 monitors for an event. (Block 545). An example approach to monitoring for an event is disclosed in further detail in connection with FIG. 7, below. In short, the example consumer advocacy system 115 waits for a message from the entity (e.g., via the connection established at block 520), waits for a threshold amount of time to have elapsed, and/or monitors third-party information to determine whether an event has occurred.

Once an event is detected, the example observer circuitry 235 and/or the example standard handler circuitry 215 determines a status of the conversation, and whether the conversation should be continued or ended. (Block 550). An example approach for determining the status of the conversation and whether to continue the conversation is described below in connection with FIG. 8. As noted above in connection with block 530, one or more status variables are identified, including an indication of whether the conversation should be continued. If the example conversation is to be continued (e.g., block 550 returns a result of “CONTINUE CONVERSATION”), control proceeds to block 525 where the example engager circuitry 220 and/or the example standard handler circuitry 215 determine a next action to be performed. Such next action may be based on, for example, the additional event detected at block 545. For example, if the entity responds with a question via the connection, the next action determined by the example engager circuitry 220 and/or the example standard handler circuitry 215 may include providing an answer to the question.

In the illustrated example of FIG. 5, subsequent to determination of a next action to be performed (block 525), the example observer circuitry 235 and/or the example standard handler circuitry 215 determine the status of the conversation prior to performance of the next action (e.g., at blocks 535, 540). Such an arrangement enables the standard handler and/or the observer circuitry 235 to monitor the next action to be performed (e.g., to monitor the next message to be sent to the entity). Such an arrangement is akin to “thinking before you speak,” rather than “speaking and then thinking about what you just said.” Such an approach is advantageous because it enables the example observer circuitry 235 and/or the example standard handler circuitry 215 to monitor the conversation for exceptional circumstances, and prevent such exceptional circumstances before they occur.

If exceptional circumstances are detected, the example observer circuitry 235 and/or the example standard handler circuitry 215 may cause the conversation to be ended (e.g., block 530 may return a result of “END CONVERSATION) before transmitting a message causing the exceptional-circumstance-causing-message to be transmitted to the entity. However, it should be understood that alternative approaches may also be used where the message to be sent to the entity is sent prior to determination of the status of the conversation (e.g., blocks 535 and 540 occur prior to block 530).

In the illustrated example of FIG. 5, blocks 525, 530, 535, and 540 represent generation of communications from the consumer advocacy system 115 towards the entity 110, while blocks 545 and 550 represent listening for communications from the entity 110 towards the consumer advocacy system 115. In the illustrated example of FIG. 5 these processes of generating and listening are shown in a serial arrangement (e.g., communicate, then listen, then communicate, then listen, etc.). However, it should be understood that the listening process and generating process could each be treated independently, and be executed in parallel with each other.

Moreover, while in the illustrated example of FIG. 5, after a connection is established with the entity, control proceeds to determining a first action at block 525, in some examples, the consumer advocacy system 115 may allow the entity 110 to be the first participant in the conversation to communicate. This is akin to the receiver of a telephone call being the first participant to say “hello”. Thus, in some examples, control might first flow to block 545 after establishing the connection at block 520, where the consumer advocacy system 115 then first awaits a message from the entity 110 via the recently established connection.

Additionally, in the illustrated example of FIG. 5, block 525 is explained as being performed by the example engager circuitry 220 and/or the example standard handler circuitry 215 and blocks 530, 550 are explained as being performed by the example observer circuitry 235 and/or the example standard handler circuitry 215, in such examples, the standard handler circuitry 215 serves to avoid use of the LLM circuitry 230 based on patterns and/or other standard conditions that result in predictable next actions that are to be taken. However, in some implementations, the standard handler circuitry 215 may be omitted. In such examples, the example engager circuitry 220 may be solely responsible for determining a next action to perform, and the observer circuitry 235 may be solely responsible for determining the status of the conversation. In some examples, the standard handler circuitry 215 may be utilized only in connection with either the engager circuitry 220 or the observer circuitry 235. Such an approach reduces the complexity of developing patterns and/or mining conversations for the same, but tends to result in higher computational expense with respect to use of the LLM circuitry 230.

If the example observer circuitry 235 and/or the example standard handler circuitry 215 determine that a conversation is to be ended (e.g., block 530 or block 550 return a result of “END CONVERSATION”), the example entity interface circuitry 240 transmits a message that ends the conversation with the entity. (Block 555). The conversation-ending message may indicate to the entity that the conversation is to be terminated (e.g., a message stating “Thank you for your time. Goodbye.”) Alternatively, the connection with the entity established a block 520 simply be terminated.

The example advocacy controller circuitry 212 then proceeds to review the conversation to determine whether the objective has been achieved. (Block 560). A value indicating whether the objective has been achieved may be included, for example, in the status variables representing the status of the conversation. If the example advocacy controller circuitry 212 determines that the objective has been achieved (e.g., block 560 returns a result of YES), the example advocacy controller circuitry 212 records entity next tasks. (Block 565). The example entity next tasks represent actions that are to be taken by the entity. Such entity next tasks may include, for example, issuing a tracking label (e.g., a shipping label) for shipment of the item to be returned, issuing a refund for the item (e.g., a previously purchased product), etc. In some examples, the entity next tasks are stored in the entity information datastore 201.

The example advocacy controller circuitry 212 records the consumer next tasks. (Block 570). The example consumer next tasks represent actions to be taken by the consumer. Such actions may include, for example, delivering the item to be returned to a courier for transit to the entity, etc. In some examples, the consumer next tasks are stored in the consumer information datastore 117.

The example advocacy controller circuitry 212 communicates a resolution message to the consumer. (Block 580). This resolution message may identify, for example, the next task that is to be performed by the consumer. In some examples, the resolution message may include a summary of the conversation with the entity (and/or an entirety of the conversation with the entity). In some examples, the resolution message is included as one of the status variables determined by the standard handler circuitry 215 and/or the observer circuitry 235 at blocks 530 and/or 550. In examples disclosed herein, the resolution message may be provided to the consumer by way of an email message, an in-app notification, an SMS message, etc.

If the example advocacy controller circuitry 212 determines that the objective of the conversation was not achieved (e.g., block 560 returns a result of NO), the example advocacy controller circuitry 212 stores a record of the communication attempt. (Block 585). The record of the communication attempt later enables the skipper circuitry 210 to determine whether the number of communication attempts meets or exceeds a threshold at block 420 of FIG. 4. In this manner, the conversation with the entity may be re-attempted at a later time. In some examples, attempting to communicate with the entity at a later time may result in a different consumer service agent being communicated with which, in some examples, may produce a different (e.g., more desirable) outcome. Moreover, in subsequent conversations, different approaches for conducting the conversation may be utilized. By trying different approaches, it can be possible to save consumer time and produce more of a preferred outcome. The example process 500 of the illustrated example of FIG. 5 then terminates, but may be repeated to conduct subsequent conversations with an entity.

FIG. 6 is a flowchart representative of example machine readable instructions and/or example operations that may be executed, instantiated, and/or performed by example programmable circuitry to implement the consumer advocacy system 115 of FIG. 2 to determine a next action to perform during the conversation with the entity. The example process 600 of the illustrated example of FIG. 6 represents the example consumer advocacy system 115 determining a next action to be performed as part of a conversation with an entity. In general, the next action will be transmission of a message to the entity. However, other actions may additionally or alternatively be identified including, for example, waiting for further information.

The example process 600 begins at block 610 where the example standard handler circuitry 215 determines whether a message (or sequence of messages) between the consumer advocacy system 115 and the entity match a known pattern. (Block 610). The example standard handler circuitry 215 determines whether the latest message (or messages) in the conversation matches a known pattern by applying patterns stored in the example pattern datastore 202 to determine whether there is a match. Examples disclosed herein, the patterns may be formatted as regular expressions that may be evaluated over the message(s). However, any other pattern detection approaches may additionally or alternatively be used such as, for example, as preprocessing the text, trie structures, algorithms such as Knuth-Morris-Pratt, Boyer-Moore, or Aho-Corasick, etc. In some examples, custom built algorithms may be profiled and benchmarked for additional efficiency improvements.

In examples disclosed herein, the patterns stored in the example pattern datastore 202 are stored in connection with corresponding message templates. If the example standard handler circuitry 215 identifies a pattern that matches the latest message(s) in the conversation (e.g., block 610 returns result of YES), the example standard handler circuitry 215 generates a message using the corresponding message template based on the matched pattern. (Block 612).

If the example standard handler circuitry 215 determines that the latest message(s) in the conversation does not match a known pattern (e.g., block 610 returns a result of NO), the example engager circuitry 220 creates a prompt for use by the large language model circuitry. (Block 615). In examples disclosed herein the prompt may include instructions to the LLM circuitry 230 for generation of a subsequent message that is to be transmitted to the entity on behalf of the consumer. In some examples the prompt includes prior messages transmitted (and/or a summary thereof) to and/or from the entity to enable a next message to be generated. By knowing a status of the conversation so far (either as a variable or by “reading”/having whole conversation), the prompt could cause the LLM circuitry 230 to “know” what is going on.

The example LLM interface circuitry 225 provides the prompts to the LLM circuitry 230. (Block 620). In some examples, the LLM interface circuitry 225 selects the LLM circuitry 230 and/or a model that is to be executed by the LLM circuitry 230. Selection of the model and/or LLM circuitry 230 may be based on, for example, an objective of the conversation, an entity involved in the conversation, a location of the consumer and/or entity, a language to be used, etc.

The LLM circuitry 230 executes a large language model, which generates a response message that is provided back to the LLM interface circuitry 225. The example engager circuitry 220 then accesses a message from the LLM circuitry 230 (e.g., via the LLM interface circuitry 225). (Block 630). In some examples, the engager circuitry 220 parses the message from the LLM to extract a message to be transmitted to the entity (and/or other information, such as an indication that no message should be sent at this time). For example, keywords and/or other data fields can be parsed from the message as needed in the output from LLM circuitry 230 to indicate nothing being sent such as “SAY-NOTHING-AND-WAIT”. This allows for more information coming from the LLM circuitry 230 and prompts and the representing of the consumer as needed.

In some examples, the response message from the LLM circuitry 230 may cause an additional objective of a conversation to be identified. For example, while interacting with an entity to return an item, a renewal of an existing service may be inquired about by the entity (e.g., a subscription delivery service). In such an example, an additional objective of negotiating a better price and/or other terms of the service may be identified. In this manner, the additional (e.g., multiple) objectives may be achieved via a single communication and/or advocacy session with the entity.

In this manner, utilizing the standard handler circuitry 215 to apply known patterns to messages in the conversation history enables the example consumer advocacy system 115 to efficiently identify subsequent messages to be transmitted to the entity. For example, the application of regular expression patterns to a message is generally a more computationally efficient task than the execution of a large language model. As a result, the example consumer advocacy system 115 reserves the use of large language model circuitry for situations where previously stored patterns did not enable identification of subsequent message to be transmitted. In other words, the cavitation expense of executing the large language model circuitry is avoided, where appropriate. As noted below in connection with the illustrated example of FIG. 11, conversations between the consumer advocacy system and an entity may later be analyzed (e.g., mined) to attempt to identify patterns of communication that result in block 610 more frequently returning a result of yes. In some examples, the use of the standard handler circuitry 215 circuitry may be omitted, such that the engager circuitry 220 utilizes the LLM circuitry 230 to determine each next action to be performed.

The example standard handler circuitry 215 evaluates the message generated at either block 612 or block 630 to determine whether the message should be transmitted. (Block 650). In some examples, the standard handler circuitry 215 or the LLM circuitry 230 may generate an output indicating that a wait action should be performed instead of sending a message in the conversation. If the message is to be transmitted (e.g., block 650 returns a result of YES), the example standard handler circuitry 215 stores the message to be transmitted to the entity in a conversation log. (Block 660). When storing the example message in the conversation log, the example standard handler circuitry notates that the message has not yet been sent to the entity. As discussed above in connection with block 530 of FIG. 5, such an approach enables the observer circuitry 235 to evaluate the message prior to the message actually being transmitted to the entity (e.g., to enable the consumer advocacy system 115 to “think before it speaks.”)

If the example standard handler circuitry 215 determines that the message should not be transmitted (e.g., block 650 returns a result of NO), the example standard handler circuitry 215 stores a wait action in the conversation log. (Block 670). Storing the weight action in conversation log enables the entity interface circuitry 240 (e.g., at block 535) to determine whether a message is to be sent. The example process 600 of the illustrated example of FIG. 6 then terminates, but may be re-executed to determine a next action to be performed when communicating with an entity.

FIG. 7 is a flowchart representative of example machine readable instructions and/or example operations that may be executed, instantiated, and/or performed by example programmable circuitry to implement the consumer advocacy system 115 of FIG. 2 to monitor for an event during the conversation with the entity. The example process 700 of the illustrated example of FIG. 7 begins when the example entity interface circuitry 240 monitors the connection with the entity for an agent interaction. (Block 710). An agent interaction may include, for example, a message, or a portion thereof, being received via the connection. In some examples, multiple portions (e.g., segments) of a message are aggregated to form a complete message. In some examples, after receiving a first segment of a message, the example entity interface circuitry 240 may wait a threshold amount of time to enable receipt of subsequent portions of the message. This enables multiple message portions (e.g., chat messages, audio segments) that are communicated in rapid succession to be treated as a single message. In other words, instead of treating the following three message portions “hold on,” “one moment,” “let me look that up for you.” as three separate messages, the three message portions can be treated as a single message: “hold on, one moment, let me look that up for you.” In examples disclosed herein, a message is considered complete when a threshold amount of time has elapsed since receipt of a most recent portion/statement of a message (e.g., without receipt of a subsequent portion/statement). Using such an approach is important when the entity interface circuitry is to communicate with the entity using an audio connection.

If a message from the agent is received (e.g., block 720 returns a result of YES), the example entity interface circuitry accesses the response message from the entity 110 (Block 730). In some examples, the entity interface circuitry 240 parses the message and/or otherwise transforms the message into a format that is usable by other components of the consumer advocacy system. For example, the message may have emojis removed and/or translated. The example entity interface circuitry 240 then stores the response message in the conversation log. (Blocks 740). The example entity interface circuitry 240 may then update the conversation status and/or the conversation log as needed. (Blocks 780).

Returning to block 720, if no message from the agent is received (e.g., block 720 returns a result of NO), the example entity interface circuitry 240 determines whether a threshold amount of time has elapsed since a prior message. (Block 750). Examples disclosed herein, the threshold amount of time may be defaulted to a threshold amount of time of three minutes. However, in some examples, this default value may be overridden based on the context of the conversation. For example, if an agent indicated that they would return to the conversation in ten minutes, the threshold amount of time may be set to fifteen minutes (e.g., to allow for an agent to return and prepare a response).

If the threshold amount of time has elapsed since a prior message (e.g., block 750 returns a result of YES), the example entity interface circuitry 240 updates the conversation status and conversation log to indicate that no message has been received in the threshold amount of time. (Block 780).

If the threshold amount of time has not elapsed since the prior message (e.g., block 750 returns a result of NO), the example third-party interface circuitry 255 monitors for an external event. (Block 760). The external event may include, for example, a return tracking/shipping label being emailed to the consumer. In this manner, the example third-party interface circuitry 255 may monitor an email account of the consumer (e.g., at a third-party email server) to determine whether such a message has been received. This allows for a subsequent response of “oh, I just got the tracking label.” However, any other third-party site and/or data source may additionally or alternatively be monitored for the external event. In some examples, the monitored information may include information provided by the consumer, which may include an instruction from the consumer to no longer proceed with the return, a new direction (e.g., an acceptable alternative), etc.

If the example third-party interface circuitry 255 determines that no external event has occurred (e.g., block 770 returns a result of NO), control returns to block 710 where the example entity interface circuitry 240 continues to monitor for agent interactions. If the example third-party interface circuitry 255 determines that the external event has occurred (e.g., block 770 returns a result of YES), the example third-party interface circuitry 255 updates the conversation status and conversation log using data associated with the external event. (Blocks 780). For example, the example third-party interface circuitry 255 may store an indication that a tracking/shipping label has been received. The example process 700 of the illustrated example of FIG. 7 then terminates, (e.g., returning control to block 550 of FIG. 5). The example process 700 of FIG. 7 may then be repeated to monitor for subsequent events in accordance with block 545 of FIG. 5.

FIG. 8 is a flowchart representative of example machine readable instructions and/or example operations that may be executed, instantiated, and/or performed by example programmable circuitry to implement the consumer advocacy system 115 of FIG. 2 to observe and determine a status of the conversation with the entity.

The example process 800 of the illustrated example of FIG. 8 corresponds to blocks 530 and/or 550 of FIG. 5, and represents the example consumer advocacy system 115 monitoring the status of the conversation and determining whether to continue the conversation. The example process 800 of FIG. 8 begins when the example standard handler circuitry 215 accesses a conversation log representing the messages that have been exchanged between the consumer advocacy system 115 and entity with respect to the connection that was opened at block 520 of FIG. 5. (Block 810).

The example standard handler circuitry 215 first attempts to process one or more patterns to determine the status of the conversation. As noted above in connection with FIG. 5, the example status may be represented by one or more variables that collectively represent the status of the conversation. Such variables may include, for example, whether the interaction is complete, whether the intent of the conversation has been achieved, was the most recent interaction from the agent a question, must an item in question be returned to obtain a refund, has a refund already been issued, is a refund amount known, as the return of the item in question been approved by the entity, is a return label been sent, the location at which the item needs to be dropped off (e.g., a courier location, a mailbox location, a locker location, a shipping entity storefront, etc.) known, etc.

The example standard handler circuitry 215 selects a pattern to be used to determine one or more status variables. (Block 815). The example pattern may be implemented as a regular expression or other type of pattern that may be used to extract and/or parse information from a conversation. For example, other approaches can be used in addition to or as an alternative to such pattern matching including, for example, preprocessing the text, trie structures (prefix tree structures), and algorithms such as Knuth-Morris-Pratt, Boyer-Moore, Aho-Corasick, etc. Additionally or alternatively, custom built algorithms can be profiled and benchmarked for additional efficiency gains. The pattern may be stored, and subsequently retrieved from, the pattern datastore 202. The example standard handler circuitry 215 applies the pattern to the conversation log to determine the status of the conversation. (Block 825). In some examples, the pattern is used to determine a subset of the status variables. In this manner, multiple patterns may be applied to attempts to determine status and conversation. In some examples, the standard handler circuitry 215 may update a prior status of the conversation based on the use of the selected pattern.

The example standard handler circuitry 215 then determines whether the status of the conversation was adequately determined. (Block 825). If the status has not been adequately determined (e.g., block 825 returns a result of NO) the example standard handler circuitry 215 determines whether there are additional patterns to test. (Block 830). If there are additional patterns to be tested (e.g., block 830 returns a result of YES), control proceeds to block 815 where an additional pattern is selected until either no additional patterns exist to be tested, or the status of the conversation is adequately determined.

If there are no additional patterns to test and the status of the conversation has not been adequately determined (e.g., both blocks 825 and 830 return a result of NO), the example observer circuitry 235 creates a prompt to provide the conversation (e.g., the conversation log) or a summary thereof to the LLM circuitry 230 along with a request for determination of the status of the conversation. (Block 835). The prompt is generated based on a prompt template, which may take in any data previously gathered, status variables, objectives, etc. In some examples, the prompt defines the status variables to the large language model while requesting the large language model identify values for the various status variables. In this manner, status variables may be utilized not only to record the status of the conversation, but also to convey such information (and/or other information) to the LLM circuitry 230.

In some examples, the prompt requests that the LLM circuitry 230 to provide its response in a particular format (e.g., a format that is parseable). For example, the example prompts may request that the LLM circuitry 230 provide the status variables back to the observer circuitry 235 utilizing JavaScript object notation (JSON) markup. However, any other format for conveying variables may additionally or alternatively be used including, for example, a comma separated value (CSV) format, an extensible markup language (XML) format, an initialization (INI) format, a text format, etc.

The example LLM interface circuitry 225 provides the prompt to the LLM circuitry 230 for execution. (Block 837). The LLM circuitry then executes a model to generate a response message. In some examples, a same model is executed by the LLM circuitry 230 in response to the prompt created by the observer circuitry 235 as is used when responding to a prompt from the engager circuitry 220. However, in some examples, separate models may be used. Moreover, different models may be used by the observer circuitry and/or the engager circuitry based on, for example, information corresponding to the prompt being created. For example, a particular LLM model may have a higher accuracy when responding to requests for detecting a tracking/shipping label, as opposed to generally determining a status of a conversation.

The response message is generated by the LLM circuitry 230 and is returned to the LLM interface circuitry 225. The example observer circuitry 235 accesses the response message from the LLM circuitry. (Block 840). The example observer circuitry 235 parses the response message to extract the status variables. In some examples, the LLM circuitry 230 may respond in a format that is not parsable. In such an example, the example observer circuitry 235 may cause the prompt to be resent to the LLM circuitry 230 until a parseable result is received. (e.g., control may return to block 835). In some examples, the subsequent prompt (e.g., a prompt requesting correction of a non-parseable response) may be altered as compared to the prior prompt (e.g., the prompt that resulted in the non-parseable response). In some examples, a non-parseable response may result in termination of the conversation and/or a notice to an administrator. Terminating the conversation may result in the conversation later being retried.

Moreover, in some examples, the observer circuitry 235 may determine whether the extraction of the status variables results in the status of the conversation being adequately determined (e.g., similar to block 825). If, for example, one or more of the status variables are not adequately determined, or determined status variables are not in agreement (e.g., a status variable indicates that a tracking/shipping label has been provided, but a number for the tracking/shipping label is not known), the example process may return to block 835 to resolve the mis-matched status variables.

At block 845, the example standard handler circuitry 215 reviews the status variables to determine whether the intent of the conversation has been achieved. (Block 845). If the intent of the conversation has been achieved (e.g., block 845 returns a result of YES), the example standard handler circuitry 215 returns a result that ends the conversation with the entity. In some examples, multiple outcomes can achieve the intent and/or intents of a conversation including, for example, denials, backup plans being utilized, information having been gathered, partial completion of an objective, etc.

If the example standard handler circuitry 215 determines that the intent of the conversation has not yet been achieved (e.g., block 845 returns a result of NO), the example standard handler circuitry 215 determines whether the status variables indicate that an exception has occurred. (Block 850). An exception may be identified when, for example, the proposed message to be sent includes profanity or other language that may be harmful to achieving the intent of the conversation. In some examples, prior messages in the conversation (including messages from the entity) may be analyzed to identify whether profanity or other language harmful to achieving an objective has occurred. If the example standard handler circuitry 215 determines that an exception has occurred (e.g., block 850 returns a result of YES), the example standard handler circuitry 215 returns a result causing the conversation to be ended. As disclosed above in connection with blocks 560 and 585, the conversation may later be re-attempted, in an effort to eventually achieve the intended result of the conversation.

If the example standard handler circuitry 215 determines that an exception has not occurred (e.g., block 850 returns a result of NO), the example standard handler circuitry 215 evaluates the status variables to determine whether the intent is likely to be achieved. (Block 855). If the example standard handler circuitry 215 determines that the intent is achievable (e.g., block 855 returns a result of YES), the example standard handler circuitry 215 returns a result indicating that the conversation is to be continued. Conversely, if the example standard handler circuitry 215 determines that the intent is not likely achievable (e.g., the agent indicates that no refund can be issued) resulting in block 855 returning a result of NO, the example standard handler circuitry 215 returns a result that causes the conversation to be ended. The example process 800 of FIG. 8 then terminates but may be re-executed at a later time (e.g., in the context of blocks 530 or 550 of FIG. 5).

FIG. 9 is a flowchart representative of example machine readable instructions and/or example operations that may be executed, instantiated, and/or performed by example programmable circuitry to implement the consumer advocacy system 115 of FIG. 2 to process a consumer next task. The example process 900 of the illustrated example of FIG. 9 begins when the example consumer interface circuitry 205 identifies an incomplete consumer next task. (Block 910). In examples disclosed herein, the consumer next task is stored in the example consumer information datastore 117. The example consumer next task represents an action that is to be taken by the consumer. Such action may include, for example, uploading a copy of a receipt, dropping off an item at a drop-off location, and/or other action that may be taken by the consumer.

In some examples, information regarding the completion of the action is stored at third-party site such as, for example, an email server, a courier tracking system, etc. The example third-party interface circuitry 255 accesses this information from the third-party site regarding the next task. (Block 920). For example, the third-party interface circuitry 255 may access a courier tracking system using a tracking number that is to be used for return of the package to determine whether the consumer has dropped off the package at a drop-off location of the courier (e.g., has the courier received the package?). Typically, once a courier receives such package, the tracking information is scanned in a timely manner, making such tracking information available to the third-party interface circuitry 255. The example consumer interface circuitry 205 determines whether the accessed information indicates that the consumer next task has been completed (e.g., delivery of the package to the courier is complete). (Block 930). If the example consumer interface circuitry 205 determines that the next task is complete (e.g., block 930 returns a result of YES), the example consumer interface circuitry 205 updates a record associated with the consumer next task in the consumer information datastore 117 as having been completed. (Block 940). The example process 900 of the illustrated example of FIG. 9 then terminates.

If the example consumer interface circuitry 205 determines the next task is not complete (e.g., block 930 returns a result of NO), the example consumer interface circuitry 205 determines whether a reminder is to be sent to the consumer. (Block 950). Such reminders may periodically be needed to, for example, remind the consumer that they have not yet dropped off the package at the courier drop-off location. If a reminder is to be sent (e.g., block 950 returns a result of YES), the example consumer interface circuitry 205 causes a reminder to be sent to the consumer. (Block 960). In some examples, the reminder is sent as an email message. However, any other approach to reminding the consumer that an action is to be taken may additionally or alternatively be used including, for example, sending an SMS message, a push notification such as an in-app notification to be displayed on the mobile device of the user, etc.

If, at block 950, the example consumer interface circuitry 205 determines the reminder is not to be sent at this time (e.g., block 950 returns a result of NO), the example consumer interface circuitry 205 determines whether the next task is still needed. (Block 970). In some examples, after multiple reminders had been sent to the consumer to return deliver an item to the courier drop-off location, the return window may have elapsed. In such an example, this may be interpreted as the consumer having changed their mind about the return and, instead, having decided to keep the item. If the next task is no longer needed (e.g., block 970 returns a result of NO), the example consumer interface circuitry 205 updates the record in the consumer information datastore associated with the consumer next task to indicate that this consumer next task is no longer needed. (Block 980). In this manner, subsequent reminders and/or investigations to determine whether the next task has been completed can be avoided.

Returning to block 970, if the next task is still needed (e.g., block 970 returns a result of YES), no further action is taken with respect to the next task. In a subsequent execution of the illustrated example the example process 900 of FIG. 9, this consumer next task may be inspected to determine whether the consumer has completed the next task (e.g., block 930 and/or 940), or it may be later determined that a reminder is to be sent to the consumer (e.g., blocks 950 and/or 960). The example process 900 of FIG. 9 then terminates, but may be re-executed periodically and/or a-periodically to identify consumer next tasks for investigation.

FIG. 10 is a flowchart representative of example machine readable instructions and/or example operations that may be executed, instantiated, and/or performed by example programmable circuitry to implement the consumer advocacy system 115 of FIG. 2 to process an entity next task. The example process 1000 of the illustrated example of FIG. 10 represents the example consumer advocacy system 115 identifying entity next tasks to be performed, and determining the status thereof. The example process 1000 of FIG. 10 begins when the example entity interface circuitry 240 identifies an entity next task. (Block 1010).

The example entity next task is represented as a record in the entity information datastore 201. In examples disclosed herein, an entity next task that has not yet been performed is identified by the example entity interface circuitry 240. The example third-party interface circuitry 255 accesses information related to the next task. (Block 1020). In some examples, the entity next task may represent an action that is to be performed by the entity including, for example, providing a tracking number for return, providing a return merchandise authorization (RMA) number, providing a credit to the consumer, shipping a replacement item, etc.

Such information may be accessible at third-party sites including, for example, an email server, a credit card information system, a courier tracking system, etc. In this manner, the example third-party interface circuitry 255 accesses information related to the next task via a third-party site. (Block 1020). The example entity interface circuitry 240 reviews the information retrieved by the example third-party interface circuitry 255 to determine whether the entity next task has been completed. (Block 1050). If the next task has been completed (e.g., the entity was expected to provide a credit to an account of the consumer, and such a credit has been detected) (e.g., block 1050 returns a result of YES), the example entity interface circuitry 240 updates the record in the entity information datastore 201 to indicate that the entity next task has been completed. (Block 1090).

In some examples, it may be advantageous to, if after a threshold amount of time has elapsed and an entity next task has not yet been performed, contact the entity on behalf of the consumer to inquire as to why the entity next task has not yet been performed and/or when the entity next task is now expected to be completed. If the example entity interface circuitry 240 determines that communication with the entity should be established (e.g., block 1060 returns a result of YES), the example entity interface circuitry 240 queues an inquiry into the status of the entity next task for communication with the entity. (Block 1070). As described above in connection with FIG. 4, the queued task may be later identified and acted upon to initiate a conversation to communicate with the entity on behalf of the consumer. (Block 1070). As a result of the communication, the example entity interface circuitry 240 updates the record associated with the next task. (Block 1072).

Returning to block 1060, in some examples, it may be premature to communicate with the entity, and/or some other reason may exist indicating that the entity should not be contacted (e.g., it is outside of the entity's business hours). The example entity interface circuitry 240 determines whether the next task is still needed. (Block 1075). If the entity next task is still needed (e.g., block 1075 returns result of YES), then no additional action is taken at this time. In this manner, a subsequent iteration of the example process 1000 of FIG. 10 will later determine the entity next task and/or whether the entity should be communicated with.

If the entity next task is still needed (e.g., block 1075 returns a result of NO), the example entity interface circuitry 240 updates the record associated with the entity next task in the entity information datastore 201 to indicate that the next task is no longer needed. (Block 1080). The example process 1000 of the illustrated example of FIG. 10 then terminates, but may be re-executed periodically and/or a-periodically to review future next entity next tasks.

FIG. 11 is a flowchart representative of example machine readable instructions and/or example operations that may be executed, instantiated, and/or performed by example programmable circuitry to implement the consumer advocacy system 115 of FIG. 2 to review conversation log(s) to identify one or more patterns.

The example process 1100 of the illustrated example of FIG. 11 represents the example consumer advocacy system 115 reviewing conversation logs to attempt to identify patterns of communication. Such patterns of communication may then be useful for storage in the example pattern datastore 202 for use by the standard handler circuitry 215. In this manner, as new patterns of communication are identified, this may enable increased efficiencies when communicating with entities on behalf of consumers. For example, subsequent messages may later be created by the standard handler circuitry 215 without having to execute the LLM circuitry 230.

The example process 1100 of the illustrated example of FIG. 11 begins when the example conversation reviewer circuitry 245 accesses one or more conversations stored in the example conversation log datastore 204. (Block 1110). The example conversation reviewer circuitry 245 filters the conversation logs. (Block 1115). In examples disclosed herein, the conversations may be filtered by, for example, the entity involved in the communication, the consumer associated with the communication, the type of item involved in the communication, an intent of the communication, etc.

The example conversation reviewer circuitry 245 then reviews the filtered conversation logs to attempt to identify recurring patterns. (Block 1120). Many different approaches to identifying a pattern within conversations may be utilized. For example, to attempt to identify such patterns, the example conversation reviewer circuitry 245 may group words and/or phrases of varying lengths together to attempt to identify phrases (e.g., n-grams) that occur frequently throughout the filtered conversation logs. In some examples, terms included in the conversation may be abstracted to a corresponding variable (e.g., order numbers, consumer names, entity names, product names, product details, etc.). For example, the phrase “My order number is 98765.” May be analyzed as if the phrase were “My order number is ORDER_NUMBER.” High-frequency phrases may then be analyzed to determine whether subsequent messages transmitted by the consumer advocacy system 115 exhibit a high similarity. Alternatively, the example conversation reviewer circuitry 245 may provide the filtered conversation logs to the LLM circuitry 230 via a prompt requesting the LLM circuitry 230 to propose patterns identified in the conversation.

The example conversation reviewer circuitry 245 then determines whether a pattern has been identified. (Block 1130). If no patterns have been identified (e.g., block 1130 returns a result of NO), the example process 1100 of the illustrated example of FIG. 11 then terminates. If an example pattern has been identified (e.g., block 1130 returns a result of YES), the example conversation reviewer circuitry 245 determines whether the patterns are already stored in the pattern datastore 202. (Block 1140). If the example pattern is not already stored in the example pattern datastore 202 (e.g., block 1140 returns a result of NO), the example conversation reviewer circuitry 245 determines a subsequent message template based on the pattern. (Block 1150). The subsequent message template may be identified based on, for example, high similarity messages being transmitted after messages that match the pattern in the conversation log. In some examples, the example conversation reviewer circuitry 245 may identify a status update (e.g., an update to one or more of the status variables) that should be applied as a result of a matching pattern. Applying a status update is useful to, for example, enable the standard handler circuitry 215 to detect the status of a conversation. The example conversation reviewer circuitry 245 then stores the pattern and the corresponding template (or instructions for updating a status variable) in the example pattern datastore 202. (Block 1160).

In some examples, the pattern and template are stored in the example pattern datastore in association with the filters that have been applied at block 1115. Storing the filter information enables the consumer advocacy system to create patterns of communication that are unique to various characteristics of the return including, particular items or types of items to be to be returned, particular entities, consumer patterns, etc. The example conversation reviewer circuitry 245 then determines whether the review of the conversation logs should continue. (Block 1170). The process may be continued if, for example, additional patterns had been identified.

Returning to block 1140, if the pattern is already stored in the pattern database (e.g., block 1140 returns a result of YES), control proceeds to block 1170 where the example conversation reviewer circuitry 245 determines whether to continue with the analysis. If, at block 1170, the example conversation reviewer circuitry 245 determines that the analysis should not be continued (e.g., block 1170 returns a result of NO), the example process 1100 of FIG. 11 terminates. The example process 1100 of the illustrated example of FIG. 11 may be re-executed periodically and/or a-periodically to attempt to identify patterns of communication that may be stored in the example pattern datastore 202.

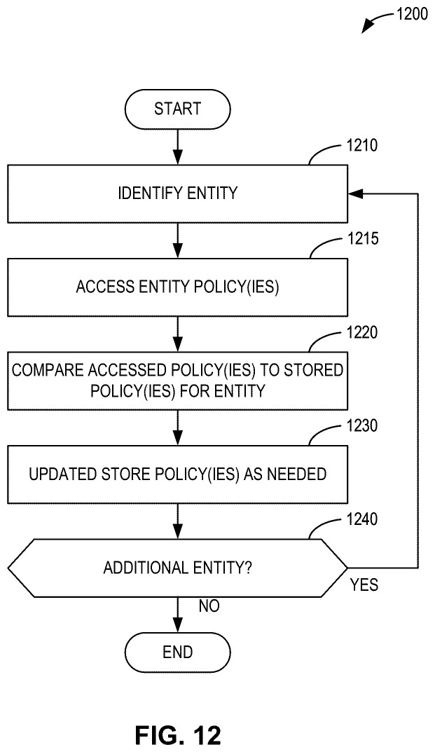

FIG. 12 is a flowchart representative of example machine readable instructions and/or example operations that may be executed, instantiated, and/or performed by example programmable circuitry to implement the consumer advocacy system 115 of FIG. 2 to review entity policy(ies). Entity policies identify the rules by which an entity will operate. For example, an entity policy may dictate that returns of an item are only accepted up to thirty days after delivery. Various complications of such policies may additionally exist including, for example, that food items are not returnable. Such policies are stored in the example entity information datastore 201 for later use when interacting with the entity.

Entity policies may change over time. Moreover, different entities may have different policies. Further still, entities operating in multiple different jurisdictions may have different policies based on the jurisdiction. The example policies stored in the entity information datastore 201 enable the example observer circuitry 235 and/or the example engager circuitry 220 to provide information about such policies to the LLM circuitry 230 for generation of a message that references the policy to the entity. Moreover, patterns and corresponding message templates used by the standard handler circuitry 215 may be developed (e.g., mined in connection with FIG. 11), to facilitate interactions with an entity based on the policies of that entity.

The example process 1200 of FIG. 12 seeks to periodically and/or a-periodically identify and document the policies of an entity. The process 1200 may be performed on a regularly recurring basis (e.g., daily, every week, every month, every ninety days, etc.) to attempt to detect a change in an entity policy. Thus, when an entity rolls out a new policy, this change and/or new policy can be detected, possibly prior to interacting with the entity based on an older version of the policy.

Alternatively, the example process 1200 of FIG. 12 may be performed a-periodically to, for example, attempt to update policy information from an entity in response to a trigger event. This may be performed, for example, in response to the detection of a new entity with which the consumer advocacy system 115 is to interact, in response to the identification of a communication failure in a conversation, in response to an instruction by an administrator of the consumer advocacy system 115, etc.

The example process 1200 of FIG. 12 begins when the example entity interface circuitry 240 identifies the entity for which a policy update is to be reviewed. (Block 1210). The example entity interface circuitry 240 accesses the entity policy(ies). (Block 1215). Such policy information is typically hosted on a website associated with the entity (e.g., in a policy document, in a frequently asked questions “FAQ” page, etc.). To that end, the example entity interface circuitry 240 accesses the policy(ies) from the website associated with the entity. However, in some examples, policy information may be captured in previous conversations with the entity. As such, the example entity interface circuitry 240 may review conversation logs stored in the example conversation log datastore 204.

The example entity interface circuitry 240 compares the policy(ies) accessed from the entity to the policy(ies) stored in association with the entity in the entity information datastore 201. (Block 1220). If differences are detected, the example entity interface circuitry 240 updates the policy(ies) stored in the entity information datastore 201 associated with the entity. (Block 1230).

The example entity interface circuitry 240 determines whether any additional entities are to be reviewed. (Block 1240). If additional entities are to be reviewed (e.g., block 1240 returns a result of YES), control proceeds to block 1210, where the process repeats for a subsequent entity. If no additional entities are to be reviewed (e.g., block 1240 returns a result of NO), the example process 1200 of FIG. 12 terminates. As noted above, the example process may later be re-executed (e.g., periodically and/or a-periodically).

In general, the consumer advocacy system 115 should support interactions with many different entities and/or types of entities. This enables consumers to have a central location at which they can manage returns with various entities. Over time, new entities will arise (e.g., new retail stores) and/or new types of entities may arise (e.g., new types of subscription services). To that end, it is possible for a consumer to desire to interact with a not-yet-supported entity. Example approaches disclosed herein enable new entities to be discovered (e.g., by way of a periodic review and/or search for new entities, at the request of a consumer or other user, etc.). To add a new entity, the consumer advocacy system 115 determines determine the industry in which the new entity is involved. In some examples, the entity can be placed in a testing phase where a limited set of text users are allowed to initiate consumer advocacy requests in association with the entity. During this testing phase, the example process 1200 of FIG. 12 may be executed to attempt to identify policies used by the entity. During the testing phase, the consumer may be warned of lowered accuracy based on potential lack of knowledge/testing. Ideally, if the industry in which the new entity operates is known, information from other similar entities might be utilized initially. Once a threshold number of consumer advocacy requests have been successfully attended to with an entity, the entity may become available to other consumers. Of course, other conditions may cause an entity to become available to other consumers via the consumer advocacy system as well.

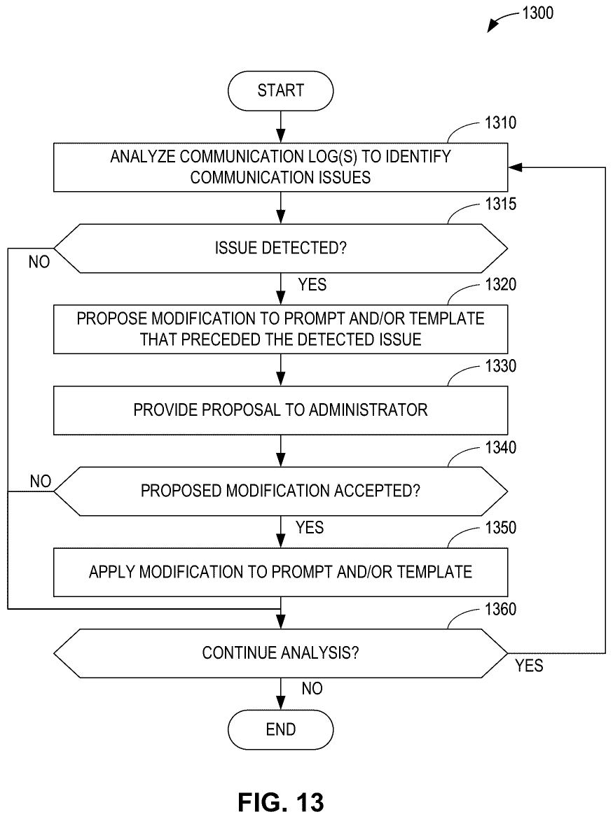

FIG. 13 is a flowchart representative of example machine readable instructions and/or example operations that may be executed, instantiated, and/or performed by example programmable circuitry to implement the consumer advocacy system 115 of FIG. 2 to review conversation log(s) to identify communication issues. Such communication issues may include, for example, hallucinations included in messages generated by the LLM circuitry 230, unnecessary communications (e.g., communications about topics not related to an objective of a conversation), communications that indicate a limit of an artificial intelligence system (e.g., a message indicating that “I cannot answer your question because I am an artificial intelligence system”), communications that are overly verbose (e.g., messages having more than a threshold number of words, characters, etc.), communications that comment about tasks that are not currently supported at the time of the message (e.g., sending an image of a product to be returned when such image would require a further activity by the consumer), etc. In some examples, the issues may include a determination that a state of the conversation (e.g., as represented by the status variables at a particular point in the conversation) does not match an expected status determination. In some other examples, the issue may include detection of a reference to an outdated and/or expired policy (which may trigger execution of the example process 1200 of FIG. 12).

The example process begins when the example conversation reviewer circuitry 245 accesses and analyzes conversation log(s) stored in the conversation log datastore 204 to identify a communication issue. (Block 1310). As noted above, many different types of communication issues may be detected. The example conversation reviewer circuitry 245 applies rules and/or logic to attempt to identify different communication issues.

The example conversation reviewer circuitry 245 determines whether a communication issue has been detected. (block 1315). If no issue is detected by the conversation reviewer circuitry 245 (e.g., block 1315 returns a result of NO), control proceeds to block 1360, where the example conversation reviewer circuitry 245 determines whether to continue the analysis. (Block 1360). If the example conversation reviewer circuitry 245 identifies a communication issue (e.g., block 1315 returns a result of YES), the example conversation reviewer circuitry 245 proposes a modification to a prompt and/or template that was used to generate a message prior to the detected communication issue. (Block 1320). The conversation reviewer circuitry 245 causes the proposed modification to be provided to an administrator of the consumer advocacy system 115. (Block 1330). The administrator may then act on the proposed modification by accepting, denying, etc. the proposed modification. Alternatively, the administrator may trigger other actions in response to the proposal including, for example, the execution of the process 1200 of FIG. 12.

The example conversation reviewer circuitry 245 determines whether the proposed modification is accepted. (Block 1340). If the proposal is not accepted (e.g., block 1340 returns a result of NO), the example process proceeds to block 1360, where the example conversation reviewer circuitry 245 determines whether to continue the analysis. If the proposed modification is accepted (e.g., block 1340 returns a result of YES), the example conversation reviewer circuitry 245 applies the modification to the prompt and/or the template for future use by the engager circuitry 220, observer circuitry 235, and/or the standard handler circuitry 215. (Block 1350).

The example conversation reviewer circuitry 245 then determines whether to continue the analysis. (Block 1360). The analysis may be continued if, for example, additional conversation logs exist that have not yet been analyzed. If additional analysis is to be performed (e.g., block 1360 returns a result of YES), control proceeds to block 1310, where the subsequent analysis is performed. If no additional analysis is to be performed (e.g., block 1360 returns a result of NO), the example process 1300 of FIG. 13 terminates. However, the example process 1300 of FIG. 13 may be re-executed periodically and/or a-periodically. For example, conversations may be reviewed on a daily basis (e.g., periodically), in response to a threshold number of failed conversations (e.g., a-periodically), etc.

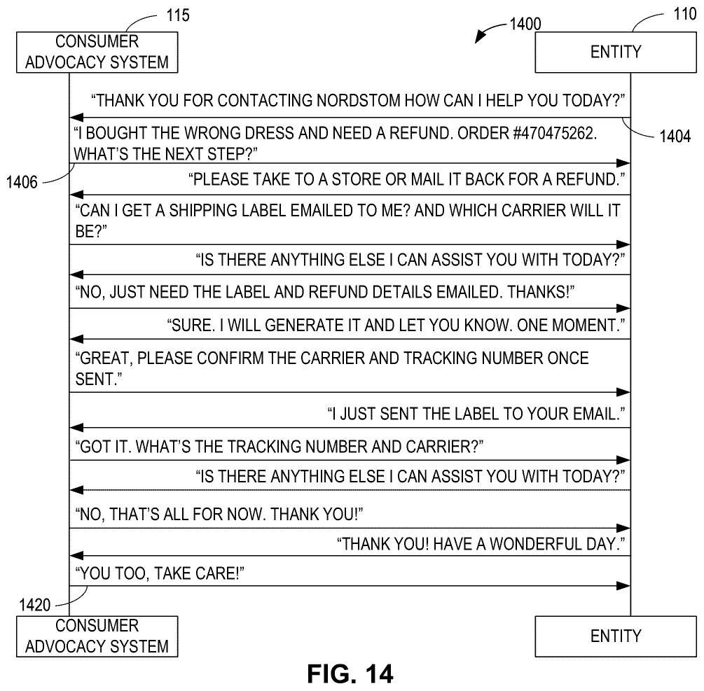

FIG. 14 is a communication diagram representing an example conversation 1400 between the consumer advocacy system 115 and the entity 110 of FIG. 1. In the illustrated example of FIG. 14, the entity 110 represents a retailer (e.g., Nordstrom). The conversation begins with the entity 110 sending a first message 1404 asking how they can help. The consumer advocacy system 115 responds 1406 on behalf of the consumer indicating that they would like to return a dress. The entity 110 provided the necessary information to process the refund and the tracking number for the returned item. The conversation ended 1420 with both parties expressing their gratitude and wishing each other well.

In this example, the consumer advocacy system 115 impersonates the consumer that is being represented. In other words, the consumer advocacy system 115 carries out the conversation as if it is the consumer itself. However, in some other examples, the consumer advocacy system 115 may identify to the entity 110 that the consumer advocacy system 115 is an artificial intelligence (AI) entity representing the consumer.

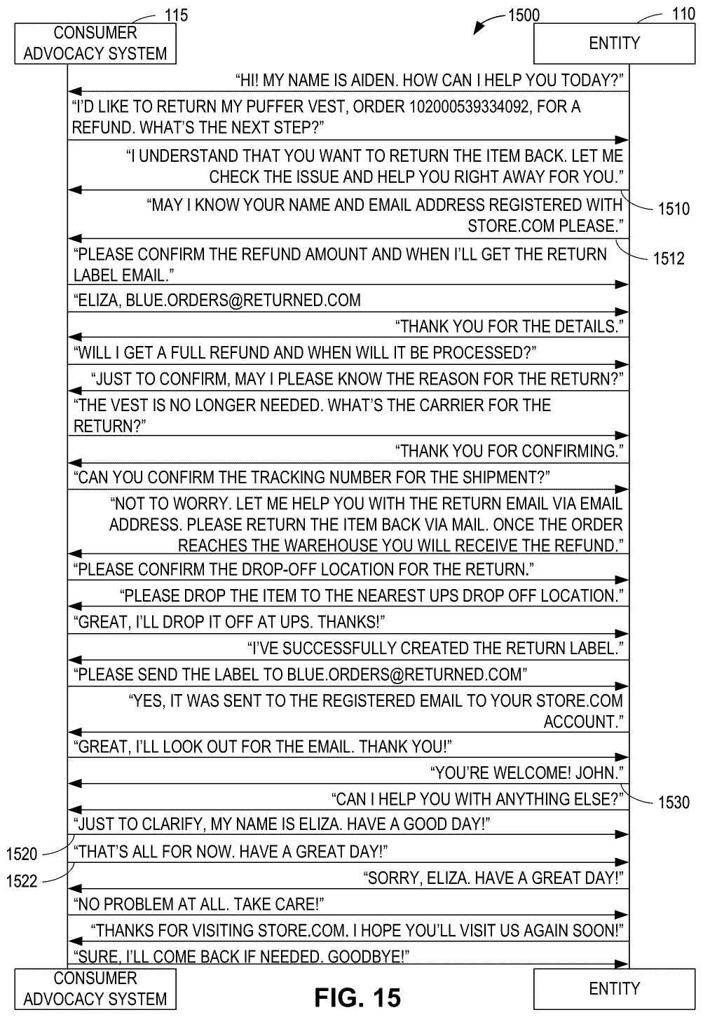

FIG. 15 is a communication diagram representing an example conversation 1500 between the consumer advocacy system 115 and the entity 110 of FIG. 1. The example conversation 1500 represents the example consumer advocacy system 115 communicating with the entity 110 on behalf of a consumer to return a puffer vest.

In the illustrated example of FIG. 15, there are instances when two sequential messages are sent by the same party without an intervening message being sent by the other party (e.g., message 1510 and message 1512 sent by the entity 110; message 1520 and message 1522 being sent by the consumer advocacy system 115). Such an example represents that the communications to the entity and from the entity may be handled independently (e.g., in parallel), as opposed to in a serial fashion.

Interestingly, in the illustrated example of FIG. 15, at message 1530, the entity 110 thanks “John” (an incorrect name), but the consumer advocacy system 115 corrects this miscommunication using message 1520.

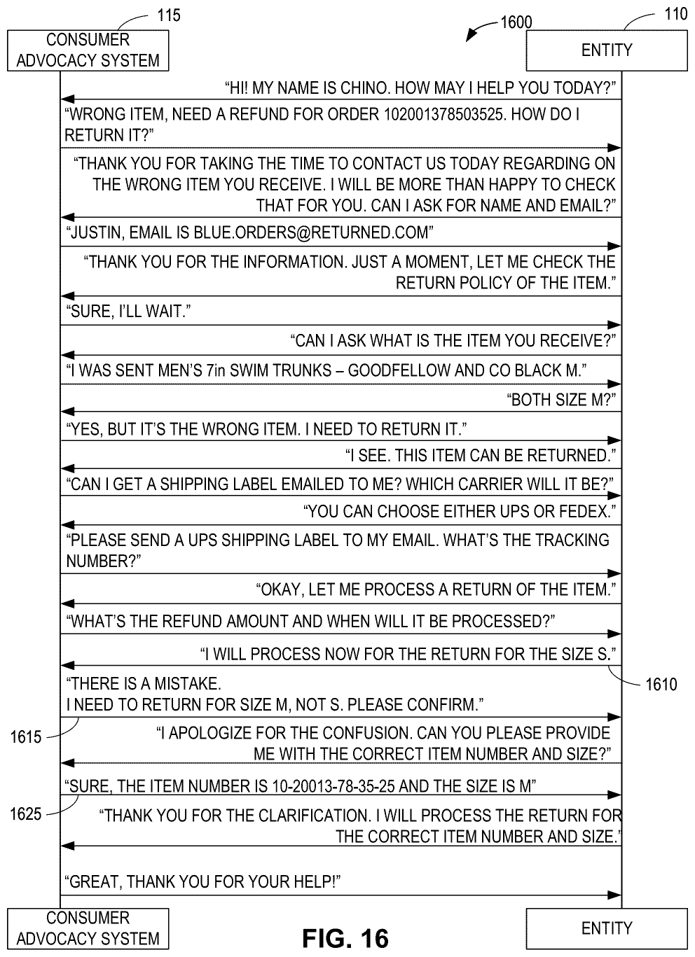

FIG. 16 is a communication diagram representing an example conversation between the consumer advocacy system 115 and the entity 110 of FIG. 1. The example communication diagram 1600 of FIG. 16 represents a conversation between the consumer advocacy system 115 and the entity 110, which involves a request by the consumer to return an item that was received in error. The consumer advocacy system 115 provides the name and email address of the consumer, as well as information about the item they received. The entity 110 then confirms the return policy and process for the item, and sends a shipping label to the consumer's email address. The consumer advocacy system 115 also requests a refund amount and when it will be processed. The entity 110 confirms the correct item number and size for the return, and processes the return for the correct item number and size. Interestingly, at message 1610, the entity 110 identifies a wrong size of the item being returned. The consumer advocacy system 115 at message 1615 identifies and corrects the mistake. Further clarification is then provided to the entity 110 at message 1625, resulting in the correct item being processed as part of the return.

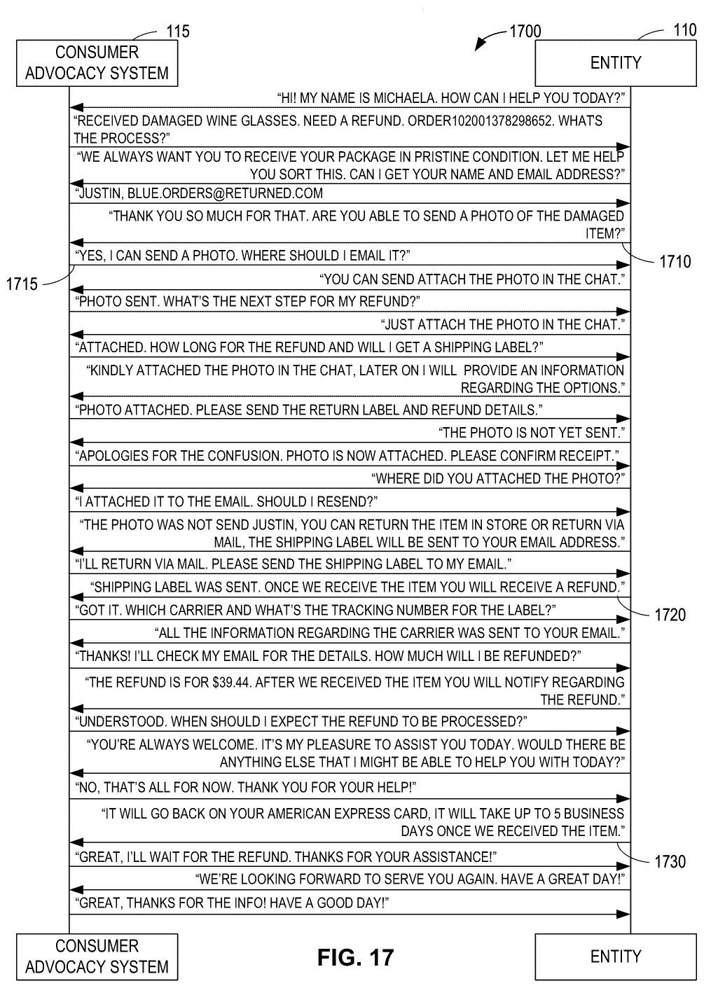

FIG. 17 is a communication diagram 1700 representing an example conversation between the consumer advocacy system 115 and the entity 110 of FIG. 1. The example conversation of FIG. 17 represents the consumer advocacy system 115 attempting to initiate a return of damaged wine glasses. In the conversation, the entity 110 requests that the consumer advocacy system 115 provide a photo of the damaged item at message 1710. The consumer advocacy system 115 erroneously responds that a photo can be sent at message 1715. However, such a photo was not provided to the consumer advocacy system 115 as part of the request for handling the return of the damaged wine glasses. The consumer advocacy system 115 later indicates that the photo had been attached, when such a photo does not exist. This issue may later be recognized by the conversation reviewer circuitry 245 as part of the execution of the example process 1300 of FIG. 13. In such an instance, the example conversation reviewer circuitry 245 might propose that a prompt that caused the message 1715 to be created by the LLM circuitry 230 be modified to instruct the LLM circuitry 230 that photos cannot be provided if they had not been previously provided by the consumer as part of the request to coordinate a return of an item.

Despite the issue concerning upload of a photo, the example conversation of FIG. 17 proceeds such that the entity provides a shipping label, which is referenced at message 1720. Further details of the return are then communicated. At the end of the conversation, a consumer next task may be created and/or stored, indicating that the consumer is to deliver the damaged item to the carrier specified in the tracking number. Likewise, an entity next task may additionally be created to confirm that the refund is provided in the time limit specified at message 1730.

FIG. 18 is a block diagram of an example programmable circuitry platform 1800 structured to execute and/or instantiate the example machine-readable instructions and/or the example operations of FIGS. 4-14 to implement the consumer advocacy system 115 of FIG. 2. The programmable circuitry platform 1800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1800 of the illustrated example includes programmable circuitry 1812. The programmable circuitry 1812 of the illustrated example is hardware. For example, the programmable circuitry 1812 can be implemented by one or more integrated circuits, logic circuits, FPGAs, microprocessors, CPUs, GPUs, DSPs, and/or microcontrollers from any desired family or manufacturer. The programmable circuitry 1812 may be implemented by one or more semiconductor based (e.g., silicon based) devices. In this example, the programmable circuitry 1812 implements the example consumer interface circuitry 205, the example skipper circuitry 210, the example advocacy controller circuitry 212, the example standard handler circuitry 215, the example engager circuitry 220, the example LLM interface circuitry 225, the example LLM circuitry 230, the example observer circuitry 235, the example entity interface circuitry 240, the example conversation reviewer circuitry 245, the example fine-tuning circuitry 250, and/or the example third-party interface circuitry 255.

The programmable circuitry 1812 of the illustrated example includes a local memory 1813 (e.g., a cache, registers, etc.). The programmable circuitry 1812 of the illustrated example is in communication with main memory 1814, 1816, which includes a volatile memory 1814 and a non-volatile memory 1816, by a bus 1818. The volatile memory 1814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1816 may be implemented by flash memory and/or any other desired type of memory device. Access to the main memory 1814, 1816 of the illustrated example is controlled by a memory controller 1817. In some examples, the memory controller 1817 may be implemented by one or more integrated circuits, logic circuits, microcontrollers from any desired family or manufacturer, or any other type of circuitry to manage the flow of data going to and from the main memory 1814, 1816.

The programmable circuitry platform 1800 of the illustrated example also includes interface circuitry 1820. The interface circuitry 1820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1822 are connected to the interface circuitry 1820. The input device(s) 1822 permit(s) a user (e.g., a human user, a machine user, etc.) to enter data and/or commands into the programmable circuitry 1812. The input device(s) 1822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1824 are also connected to the interface circuitry 1820 of the illustrated example. The output device(s) 1824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1820 of the illustrated example, thus, typically includes a graphics driver card, a graphics driver chip, and/or graphics processor circuitry such as a GPU.

The interface circuitry 1820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1800 of the illustrated example also includes one or more mass storage discs or devices 1828 to store firmware, software, and/or data. Examples of such mass storage discs or devices 1828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1832, which may be implemented by the machine readable instructions of FIGS. 4-14, may be stored in the mass storage device 1828, in the volatile memory 1814, in the non-volatile memory 1816, and/or on at least one non-transitory computer readable storage medium such as a CD or DVD which may be removable.

FIG. 19 is a block diagram of an example implementation of the programmable circuitry 1812 of FIG. 18. In this example, the programmable circuitry 1812 of FIG. 18 is implemented by a microprocessor 1900. For example, the microprocessor 1900 may be a general-purpose microprocessor (e.g., general-purpose microprocessor circuitry). The microprocessor 1900 executes some or all of the machine-readable instructions of the flowcharts of FIGS. 4-14 to effectively instantiate the circuitry of FIG. 2 as logic circuits to perform operations corresponding to those machine-readable instructions. In some such examples, the circuitry of FIG. 2 is instantiated by the hardware circuits of the microprocessor 1900 in combination with the machine-readable instructions. For example, the microprocessor 1900 may be implemented by multi-core hardware circuitry such as a CPU, a DSP, a GPU, an XPU, etc. Although it may include any number of example cores 1902 (e.g., 1 core), the microprocessor 1900 of this example is a multi-core semiconductor device including N cores. The cores 1902 of the microprocessor 1900 may operate independently or may cooperate to execute machine readable instructions. For example, machine code corresponding to a firmware program, an embedded software program, or a software program may be executed by one of the cores 1902 or may be executed by multiple ones of the cores 1902 at the same or different times. In some examples, the machine code corresponding to the firmware program, the embedded software program, or the software program is split into threads and executed in parallel by two or more of the cores 1902. The software program may correspond to a portion or all of the machine-readable instructions and/or operations represented by the flowcharts of FIGS. 4-14.

The cores 1902 may communicate by a first example bus 1904. In some examples, the first bus 1904 may be implemented by a communication bus to effectuate communication associated with one(s) of the cores 1902. For example, the first bus 1904 may be implemented by at least one of an Inter-Integrated Circuit (I2C) bus, a Serial Peripheral Interface (SPI) bus, a PCI bus, or a PCIe bus. Additionally or alternatively, the first bus 1904 may be implemented by any other type of computing or electrical bus. The cores 1902 may obtain data, instructions, and/or signals from one or more external devices by example interface circuitry 1906. The cores 1902 may output data, instructions, and/or signals to the one or more external devices by the interface circuitry 1906. Although the cores 1902 of this example include example local memory 1920 (e.g., Level 1 (L1) cache that may be split into an L1 data cache and an Li instruction cache), the microprocessor 1900 also includes example shared memory 1910 that may be shared by the cores (e.g., Level 2 (L2 cache)) for high-speed access to data and/or instructions. Data and/or instructions may be transferred (e.g., shared) by writing to and/or reading from the shared memory 1910. The local memory 1920 of each of the cores 1902 and the shared memory 1910 may be part of a hierarchy of storage devices including multiple levels of cache memory and the main memory (e.g., the main memory 1814, 1816 of FIG. 18). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1902 may be referred to as a CPU, DSP, GPU, etc., or any other type of hardware circuitry. Each core 1902 includes control unit circuitry 1914, arithmetic and logic (AL) circuitry (sometimes referred to as an ALU) 1916, a plurality of registers 1918, the local memory 1920, and a second example bus 1922. Other structures may be present. For example, each core 1902 may include vector unit circuitry, single instruction multiple data (SIMD) unit circuitry, load/store unit (LSU) circuitry, branch/jump unit circuitry, floating-point unit (FPU) circuitry, etc. The control unit circuitry 1914 includes semiconductor-based circuits structured to control (e.g., coordinate) data movement within the corresponding core 1902. The AL circuitry 1916 includes semiconductor-based circuits structured to perform one or more mathematic and/or logic operations on the data within the corresponding core 1902. The AL circuitry 1916 of some examples performs integer-based operations. In other examples, the AL circuitry 1916 also performs floating-point operations. In yet other examples, the AL circuitry 1916 may include first AL circuitry that performs integer-based operations and second AL circuitry that performs floating-point operations. In some examples, the AL circuitry 1916 may be referred to as an Arithmetic Logic Unit (ALU).

The registers 1918 are semiconductor-based structures to store data and/or instructions such as results of one or more of the operations performed by the AL circuitry 1916 of the corresponding core 1902. For example, the registers 1918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1918 may be arranged in a bank as shown in FIG. 19. Alternatively, the registers 1918 may be organized in any other arrangement, format, or structure, such as by being distributed throughout the core 1902 to shorten access time. The second bus 1922 may be implemented by at least one of an I2C bus, a SPI bus, a PCI bus, or a PCIe bus.

Each core 1902 and/or, more generally, the microprocessor 1900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1900 is a semiconductor device fabricated to include many transistors interconnected to implement the structures described above in one or more integrated circuits (ICs) contained in one or more packages.

The microprocessor 1900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1900, in the same chip package as the microprocessor 1900 and/or in one or more separate packages from the microprocessor 1900.

FIG. 20 is a block diagram of another example implementation of the programmable circuitry 1812 of FIG. 18. In this example, the programmable circuitry 1812 is implemented by FPGA circuitry 2000. For example, the FPGA circuitry 2000 may be implemented by an FPGA. The FPGA circuitry 2000 can be used, for example, to perform operations that could otherwise be performed by the example microprocessor 1900 of FIG. 19 executing corresponding machine-readable instructions. However, once configured, the FPGA circuitry 2000 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1900 of FIG. 19 described above (which is a general purpose device that may be programmed to execute some or all of the machine readable instructions represented by the flowchart(s) of FIGS. 4-14 but whose interconnections and logic circuitry are fixed once fabricated), the FPGA circuitry 2000 of the example of FIG. 20 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-14. In particular, the FPGA circuitry 2000 may be thought of as an array of logic gates, interconnections, and switches. The switches can be programmed to change how the logic gates are interconnected by the interconnections, effectively forming one or more dedicated logic circuits (unless and until the FPGA circuitry 2000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-14. As such, the FPGA circuitry 2000 may be configured and/or structured to effectively instantiate some or all of the operations/functions corresponding to the machine readable instructions of the flowchart(s) of FIGS. 4-14 as dedicated logic circuits to perform the operations/functions corresponding to those software instructions in a dedicated manner analogous to an ASIC. Therefore, the FPGA circuitry 2000 may perform the operations/functions corresponding to the some or all of the machine readable instructions of FIGS. 4-14 faster than the general-purpose microprocessor can execute the same.

In the example of FIG. 20, the FPGA circuitry 2000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 2000 of FIG. 20 may access and/or load the binary file to cause the FPGA circuitry 2000 of FIG. 20 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2000 of FIG. 20 to cause configuration and/or structuring of the FPGA circuitry 2000 of FIG. 20, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 2000 of FIG. 20 may access and/or load the binary file to cause the FPGA circuitry 2000 of FIG. 20 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2000 of FIG. 20 to cause configuration and/or structuring of the FPGA circuitry 2000 of FIG. 20, or portion(s) thereof.

The FPGA circuitry 2000 of FIG. 20, includes example input/output (I/O) circuitry 2002 to obtain and/or output data to/from example configuration circuitry 2004 and/or external hardware 2006. For example, the configuration circuitry 2004 may be implemented by interface circuitry that may obtain a binary file, which may be implemented by a bit stream, data, and/or machine-readable instructions, to configure the FPGA circuitry 2000, or portion(s) thereof. In some such examples, the configuration circuitry 2004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 2006 may be implemented by external hardware circuitry. For example, the external hardware 2006 may be implemented by the microprocessor 1900 of FIG. 19.

The FPGA circuitry 2000 also includes an array of example logic gate circuitry 2008, a plurality of example configurable interconnections 2010, and example storage circuitry 2012. The logic gate circuitry 2008 and the configurable interconnections 2010 are configurable to instantiate one or more operations/functions that may correspond to at least some of the machine-readable instructions of FIGS. 4-14 and/or other desired operations. The logic gate circuitry 2008 shown in FIG. 20 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2008 to enable configuration of the electrical structures and/or the logic gates to form circuits to perform desired operations/functions. The logic gate circuitry 2008 may include other electrical structures such as look-up tables (LUTs), registers (e.g., flip-flops or latches), multiplexers, etc.

The configurable interconnections 2010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2008 to program desired logic circuits.

The storage circuitry 2012 of the illustrated example is structured to store result(s) of the one or more of the operations performed by corresponding logic gates. The storage circuitry 2012 may be implemented by registers or the like. In the illustrated example, the storage circuitry 2012 is distributed amongst the logic gate circuitry 2008 to facilitate access and increase execution speed.

The example FPGA circuitry 2000 of FIG. 20 also includes example dedicated operations circuitry 2014. In this example, the dedicated operations circuitry 2014 includes special purpose circuitry 2016 that may be invoked to implement commonly used functions to avoid the need to program those functions in the field. Examples of such special purpose circuitry 2016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2000 may also include example general purpose programmable circuitry 2018 such as an example CPU 2020 and/or an example DSP 2022. Other general purpose programmable circuitry 2018 may additionally or alternatively be present such as a GPU, an XPU, etc., that can be programmed to perform other operations.

Although FIGS. 19 and 20 illustrate two example implementations of the programmable circuitry 1812 of FIG. 18, many other approaches are contemplated. For example, FPGA circuitry may include an on-board CPU, such as one or more of the example CPU 2020 of FIG. 19. Therefore, the programmable circuitry 1812 of FIG. 18 may additionally be implemented by combining at least the example microprocessor 1900 of FIG. 19 and the example FPGA circuitry 2000 of FIG. 20. In some such hybrid examples, one or more cores 1902 of FIG. 19 may execute a first portion of the machine readable instructions represented by the flowchart(s) of FIGS. 4-14 to perform first operation(s)/function(s), the FPGA circuitry 2000 of FIG. 20 may be configured and/or structured to perform second operation(s)/function(s) corresponding to a second portion of the machine readable instructions represented by the flowcharts of FIGS. 4-14, and/or an ASIC may be configured and/or structured to perform third operation(s)/function(s) corresponding to a third portion of the machine readable instructions represented by the flowcharts of FIGS. 4-14.

It should be understood that some or all of the circuitry of FIG. 2 may, thus, be instantiated at the same or different times. For example, same and/or different portion(s) of the microprocessor 1900 of FIG. 19 may be programmed to execute portion(s) of machine-readable instructions at the same and/or different times. In some examples, same and/or different portion(s) of the FPGA circuitry 2000 of FIG. 20 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1900 of FIG. 19 may execute machine readable instructions in one or more threads executing concurrently and/or in series. In some examples, the FPGA circuitry 2000 of FIG. 20 may be configured and/or structured to carry out operations/functions concurrently and/or in series. Moreover, in some examples, some or all of the circuitry of FIG. 2 may be implemented within one or more virtual machines and/or containers executing on the microprocessor 1900 of FIG. 19.

In some examples, the programmable circuitry 1812 of FIG. 18 may be in one or more packages. For example, the microprocessor 1900 of FIG. 19 and/or the FPGA circuitry 2000 of FIG. 20 may be in one or more packages. In some examples, an XPU may be implemented by the programmable circuitry 1812 of FIG. 18, which may be in one or more packages. For example, the XPU may include a CPU (e.g., the microprocessor 1900 of FIG. 19, the CPU 2020 of FIG. 20, etc.) in one package, a DSP (e.g., the DSP 2022 of FIG. 20) in another package, a GPU in yet another package, and an FPGA (e.g., the FPGA circuitry 2000 of FIG. 20) in still yet another package.

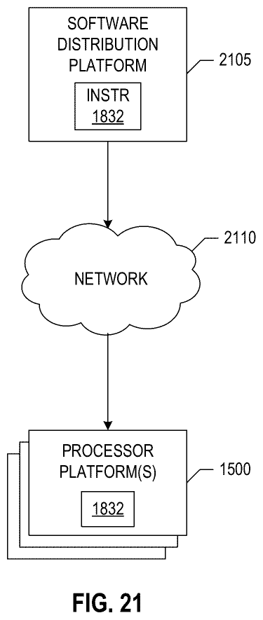

A block diagram illustrating an example software distribution platform 2105 to distribute software such as the example machine readable instructions 1832 of FIG. 18 to other hardware devices (e.g., hardware devices owned and/or operated by third parties from the owner and/or operator of the software distribution platform) is illustrated in FIG. 21. The example software distribution platform 2105 may be implemented by any computer server, data facility, cloud service, etc., capable of storing and transmitting software to other computing devices. The third parties may be customers of the entity owning and/or operating the software distribution platform 2105. For example, the entity that owns and/or operates the software distribution platform 2105 may be a developer, a seller, and/or a licensor of software such as the example machine readable instructions 1832 of FIG. 18. The third parties may be consumers, users, retailers, OEMs, etc., who purchase and/or license the software for use and/or re-sale and/or sub-licensing. In the illustrated example, the software distribution platform 2105 includes one or more servers and one or more storage devices. The storage devices store the machine-readable instructions 1832, which may correspond to the example machine readable instructions of FIGS. 4-14, as described above. The one or more servers of the example software distribution platform 2105 are in communication with an example network 2110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1832 from the software distribution platform 2105. For example, the software, which may correspond to the example machine readable instructions of FIG. 4-14, may be downloaded to the example programmable circuitry platform 1800, which is to execute the machine-readable instructions 1832 to implement the consumer advocacy system 115. In some examples, one or more servers of the software distribution platform 2105 periodically offer, transmit, and/or force updates to the software (e.g., the example machine readable instructions 1832 of FIG. 18) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable interactions with an entity on behalf of a consumer for the purpose of advocating on behalf of the consumer. Disclosed systems, apparatus, articles of manufacture, and methods improve the efficiency of using a computing device by utilizing large language models to generate text that can be used to advocate for the consumer. In some examples, further efficiency improvements are made by the use of standard handler circuitry that avoids use of the execution of a large language model. Disclosed systems, apparatus, articles of manufacture, and methods are accordingly directed to one or more improvement(s) in the operation of a machine such as a computer or other electronic and/or mechanical device. In some examples, waste is reduced by enabling returns, donations, recycling, reuse, etc. of unwanted items. Such waste reduction is a significant advance in a world of limited resources facing concerns such as climate change. Thus, examples disclosed herein can advance a “green” agenda, thereby creating significant positive impacts on the environment.

Example methods, apparatus, systems, and articles of manufacture for consumer advocacy using a large language model are disclosed herein. Further examples and combinations thereof include the following:
Example 1 includes at least one non-transitory computer readable medium comprising machine executable instructions to cause at least one programmable circuit to at least obtain a first message from a large language model based on a return request provided by a consumer, the return request associated with a previously purchased product to be returned to an entity, cause transmission of the first message to the entity to request authorization of the return of the previously purchased product, obtain a second message from the large language model, the second message based on the first message and a first response, the first response from the entity in response to the first message, cause transmission of the second message to the entity to continue the request to return the previously purchased product, and cause communication of a resolution message to inform the consumer of the resolution of the request to return the previously purchased product.

Example 2 includes the at least one non-transitory computer readable medium of example 1, wherein the resolution message is to instruct the consumer to deliver the previously purchased product to a location.

Example 3 includes the at least one non-transitory computer readable medium of example 2, wherein the location is a shipping drop-off location.

Example 4 includes the at least one non-transitory computer readable medium of any one of examples 1 through 3, wherein the resolution message is to inform the consumer of permission to discard the previously purchased product.

Example 5 includes the at least one non-transitory computer readable medium of any one of examples 1 through 4, wherein the resolution includes an amount of money to be returned to the consumer.

Example 6 includes the at least one non-transitory computer readable medium of example 5, wherein the amount of money to be returned to the consumer is based on a return fee.

Example 7 includes the at least one non-transitory computer readable medium of any one of examples 1 through 6, wherein the resolution message includes an indication of a date by which a return activity is to occur.

Example 8 includes the at least one non-transitory computer readable medium of any one of examples 1 through 7, the machine executable instructions are to cause one or more of the at least one programmable circuit to analyze a conversation log to determine whether an objective of the return request has been accomplished, the conversation log including the first message, the first response, the second message, and a second response, and generate the resolution message based on the conversation log.

Example 9 includes the at least one non-transitory computer readable medium of example 8, wherein the large language model is a first large language model, and to analyze the conversation log, at least one of the at least one programmable circuit is to obtain a third message from a second large language model based on the conversation log.

Example 10 includes the at least one non-transitory computer readable medium of example 9, wherein the first large language model is the same as the second large language model.

Example 11 includes the at least one non-transitory computer readable medium of example 8, wherein the instructions are to cause one or more of the at least one programmable circuit to determine a level of success of completion of the objective of the return request, the level of success including at least one of partial success, divergent success, or complete success.

Example 12 includes the at least one non-transitory computer readable medium of example 8, wherein the instructions are to cause one or more of the at least one programmable circuit to, after the determination that the objective of the return request has been accomplished record a consumer next task for resolution of the return of the previously purchased product, record an entity next task for resolution of the return of the previously purchased product.

Example 13 includes the at least one non-transitory computer readable medium of example 12, wherein the consumer next task includes shipping the previously purchased product to a destination.

Example 14 includes the at least one non-transitory computer readable medium of example 12, wherein the entity next task includes issuing a refund for the previously purchased product.

Example 15 includes the at least one non-transitory computer readable medium of example 12, wherein the instructions are to cause one or more of the at least one programmable circuit to, after a determination that the consumer next task or the entity next task have not been performed, cause transmission of a reminder message to at least one of the consumer or the entity.

Example 16 includes the at least one non-transitory computer readable medium of any one of examples 1 through 15, wherein the instructions are to cause one or more of the at least one programmable circuit to access a purchase record of the previously purchased product from the entity, and generate a prompt based on the purchase record, the first message obtained based on the prompt.

Example 17 includes the at least one non-transitory computer readable medium of example 16, wherein the instructions are to cause one or more of the at least one programmable circuit to identify a previous communication from the entity, and the prompt includes at least a portion of the previous communication.

Example 18 includes the at least one non-transitory computer readable medium of example 17, wherein the previous communication includes at least one of a policy, an answer to a frequently asked question, or an email message from the entity to the consumer.

Example 19 includes the at least one non-transitory computer readable medium of any one of examples 1 through 18, wherein the resolution message is to instruct the consumer to provide the previously purchased product to a delivery service.

Example 20 includes the at least one non-transitory computer readable medium of any one of examples 1 through 19, wherein the resolution message includes a shipping label to be used for shipment of the previously purchased product.

Example 21 includes the at least one non-transitory computer readable medium of any one of examples 1 through 20, wherein the instructions are to cause one or more of the at least one programmable circuit to access a plurality of statements from the entity to obtain the first response, a last one of the plurality of statements identified when a threshold amount of time has elapsed without receipt of a subsequent statement, the first response corresponding to a combination of the plurality of statements.

Example 22 includes the at least one non-transitory computer readable medium of any one of examples 1 through 21, wherein the instructions are to cause one or more of the at least one programmable circuit to analyze the first message to determine if the second message can be generated using a message template, and generate the second message with the message template.

Example 23 includes the at least one non-transitory computer readable medium of example 22, wherein the analysis of whether the second message can be generated using the message template is based on a list of patterns and corresponding message templates, the second message generated based on the message template corresponding to a pattern that matches the first response.

Example 24 includes the at least one non-transitory computer readable medium of example 22, wherein the large language model is a first large language model, and the instructions are to cause one or more of the programmable circuit to, after a determination that the second message cannot be generated using the message template generate a second prompt based on the first response and the return request, and obtain the second message from the first large language model based on the second prompt.

Example 25 includes the at least one non-transitory computer readable medium of any one of examples 1 through 24, wherein the first message, the first response, the second message, and a second response are stored in a conversation log, and the instructions are to cause one or more of the at least one programmable circuit to analyze the conversation log to identify similar response messages and corresponding subsequent messages, generate a pattern representing similar response messages, generate a message template representing similar corresponding subsequent messages, and record the pattern and the message template.

Example 26 includes the at least one non-transitory computer readable medium of example 25, wherein the conversation log includes conversations from other product return activities.

Example 27 includes the at least one non-transitory computer readable medium of example 26, wherein to analyze the conversation log, the instructions are to cause one or more of the at least one programmable circuit to filter the conversation log to conversations associated with the entity.

Example 28 includes the at least one non-transitory computer readable medium of example 26, wherein to analyze the conversation log, the instructions are to cause one or more of the at least one programmable circuit to filter the conversation log based on a type of the previously purchased product.

Example 29 includes the at least one non-transitory computer readable medium of example 26, wherein to analyze the conversation log, the instructions are to cause one or more of the at least one programmable circuit to filter the conversation log based on a location of the consumer.

Example 30 includes the at least one non-transitory computer readable medium of example 26, wherein to analyze the conversation log, the instructions are to cause one or more of the at least one programmable circuit to filter the conversation log based on a consumer preference.

Example 31 includes the at least one non-transitory computer readable medium of any one of examples 1 through 30, wherein the instructions are to cause one or more of the at least one programmable circuit to analyze an image of a receipt captured to identify the previously purchased product.

Example 32 includes the at least one non-transitory computer readable medium of any one of examples 1 through 31, wherein the instructions are to cause one or more of the at least one programmable circuit to analyze an email communication from the entity to identify the previously purchased product.

Example 33 includes the at least one non-transitory computer readable medium of any one of examples 1 through 32, wherein the instructions are to cause one or more of the at least one programmable circuit to format the first message as audio.

Example 34 includes the at least one non-transitory computer readable medium of example 33, wherein the first response is audio.

Example 35 includes the at least one non-transitory computer readable medium of any one of examples 1 through 34, wherein the instructions are to cause one or more of the at least one programmable circuit to enter the first message into a web browser.

Example 36 includes the at least one non-transitory computer readable medium of any one of examples 1 through 34, wherein the instructions are to cause one or more of the at least one programmable circuit to cause transmission of a communication using a web socket.

Example 37 includes the at least one non-transitory computer readable medium of any one of examples 1 through 36, wherein the return request is obtained via an interaction of the consumer with a mobile device.

Example 38 includes the at least one non-transitory computer readable medium of any one of examples 1 through 37, wherein the return request is obtained using a first natural language, and the first message is in a second natural language different from the first natural language.

Example 39 includes the at least one non-transitory computer readable medium of any one of examples 1 through 38, wherein the large language model is implemented separately from the at least one programmable circuit.

Example 40 includes an apparatus comprising interface circuitry, machine-readable instructions, and at least one processor circuit to be programmed by the machine-readable instructions to obtain a first message from a large language model based on a return request provided by a consumer, the return request associated with a previously purchased product to be returned to an entity, cause transmission of the first message to the entity to request authorization of the return of the previously purchased product, obtain a second message from the large language model, the second message based on the first message and a first response, the first response from the entity in response to the first message, cause transmission of the second message to the entity to continue the request to return the previously purchased product, and cause transmission of a resolution message to inform the consumer of the resolution of the request to return the previously purchased product.

Example 41 includes the apparatus of example 40, wherein the resolution message is to instruct the consumer to deliver the previously purchased product to a location.

Example 42 includes the apparatus of example 41, wherein the location is a shipping drop-off location.

Example 43 includes the apparatus of any one of examples 40 through 42, wherein the resolution message is to inform the consumer that they are allowed to discard the previously purchased product.

Example 44 includes the apparatus of any one of examples 40 through 43, wherein the resolution includes an identification of a monetary refund to be returned to the consumer.

Example 45 includes the apparatus of example 44, wherein the identification of the monetary refund excludes a return fee.

Example 46 includes the apparatus of any one of examples 40 through 45, wherein the resolution message includes an indication of a date by which a return task is to occur.

Example 47 includes the apparatus of any one of examples 40 through 46, wherein one or more of the at least one processor circuit is to analyze a conversation log to determine whether an objective of the return request has been accomplished, the conversation log including the first message, the first response, the second message, and a second response, and generate the resolution message based on the conversation log.

Example 48 includes the apparatus of example 47, wherein the large language model is a first large language model, and to analyze the conversation log, one or more of the at least one processor circuit is to obtain a third message from a second large language model based on the conversation log.

Example 49 includes the apparatus of example 48, wherein the first large language model is the same as the second large language model.

Example 50 includes the apparatus of example 47, wherein one or more of the at least one processor circuit is to determine a level of success of completion of the objective of the return request, the level of success including at least one of partial success, divergent success, or complete success.

Example 51 includes the apparatus of example 47, wherein one or more of the at least one processor circuit is to, after the determination that the objective of the return request has been accomplished record a consumer next task for resolution of the return of the previously purchased product, record an entity next task to resolve the return of the previously purchased product.

Example 52 includes the apparatus of example 51, wherein the consumer next task includes shipping the previously purchased product to a destination.

Example 53 includes the apparatus of example 51, wherein the entity next task includes issuing a refund for the previously purchased product.

Example 54 includes the apparatus of example 51, wherein one or more of the at least one processor circuit is to, after a determination that the consumer next task or the entity next task have not been performed, cause transmission of a reminder message to at least one of the consumer or the entity.

Example 55 includes the apparatus of any one of examples 40 through 54, wherein one or more of the at least one processor circuit is to access a purchase record of the previously purchased product from the entity, and generate a prompt based on the purchase record, the first message obtained based on the prompt.

Example 56 includes the apparatus of example 55, wherein one or more of the at least one processor circuit is to identify a previous communication from the entity, and the prompt includes at least a portion of the previous communication.

Example 57 includes the apparatus of example 56, wherein the previous communication includes at least one of a policy, an answer to a frequently asked question, or an email message from the entity to the consumer.

Example 58 includes the apparatus of any one of examples 40 through 57, wherein the resolution message is to instruct the consumer to provide the previously purchased product to a delivery service.

Example 59 includes the apparatus of any one of examples 40 through 58, wherein the resolution message includes a shipping label to be used for shipment of the previously purchased product.

Example 60 includes the apparatus of any one of examples 40 through 59, wherein one or more of the at least one processor circuit is to access a plurality of statements from the entity to obtain the first response, a last one of the plurality of statements identified when a threshold amount of time has elapsed without receipt of a subsequent statement, the first response corresponding to a combination of the plurality of statements.

Example 61 includes the apparatus of any one of examples 40 through 60, wherein one or more of the at least one processor circuit is to analyze the first message to determine if the second message can be generated using a message template, and generate the second message based on the message template.

Example 62 includes the apparatus of example 61, wherein the analysis of whether the second message can be generated using the message template is based on a list of patterns and corresponding message templates, and one or more of the at least one processor circuit is to generate the second message using the message template corresponding to a pattern that matches the first response.

Example 63 includes the apparatus of example 61, wherein the large language model is a first large language model, and one or more of the at least one processor circuit is to, after a determination that the second message cannot be generated using the message template generate a second prompt based on the first response and the return request, and obtain the second message from the first large language model based on the second prompt.

Example 64 includes the apparatus of any one of examples example 40, wherein the first message, the first response, the second message, and a second response are stored in a conversation log, and one or more of the at least one processor circuit is to analyze the conversation log to identify similar response messages and corresponding subsequent messages, generate a pattern representing similar response messages, generate a message template representing similar corresponding subsequent messages, and record the pattern and the message template.

Example 65 includes the apparatus of example 64, wherein the conversation log includes conversations from other product return activities.

Example 66 includes the apparatus of example 65, wherein to analyze the conversation log, one or more of the at least one processor circuit is to filter the conversation log to conversations associated with the entity.

Example 67 includes the apparatus of example 65, wherein to analyze the conversation log, one or more of the at least one processor circuit is to filter the conversation log based on a type of the previously purchased product.

Example 68 includes the apparatus of example 65, wherein to analyze the conversation log, one or more of the at least one processor circuit is to filter the conversation log based on a location of the consumer.

Example 69 includes the apparatus of example 65, wherein to analyze the conversation log, one or more of the at least one processor circuit is to filter the conversation log based on a consumer preference.

Example 70 includes the apparatus of any one of examples 40 through 69, wherein one or more of the at least one processor circuit is to analyze an image of a receipt captured to identify the previously purchased product.

Example 71 includes the apparatus of any one of examples 40 through 70, wherein one or more of the at least one processor circuit is to analyze an email communication from the entity to identify the previously purchased product.

Example 72 includes the apparatus of any one of examples 40 through 71, wherein to transmit the first message to the entity, and one or more of the at least one processor circuit is to format the first message as audio.

Example 73 includes the apparatus of example 72, wherein the first response is audio.

Example 74 includes the apparatus of any one of examples 40 through 73, wherein to transmit the first message to the entity, one or more of the at least one processor circuit is to enter the first message into a web browser.

Example 75 includes the apparatus of any one of examples 40 through 74, wherein to transmit the first message to the entity, one or more of the at least one processor circuit is to cause transmission of a communication using a web socket.

Example 76 includes the apparatus of any one of examples 40 through 75, wherein the return request is received via an interaction of the consumer with a mobile device.

Example 77 includes the apparatus of any one of examples 40 through 76, wherein the return request is received using a first natural language, and the first message is obtained in a second natural language different from the first natural language.

Example 78 includes the apparatus of any one of examples 40 through 77, wherein the large language model is implemented at large language model circuitry that is separate from the apparatus.

Example 79 includes a method comprising accessing a message from a remote entity, the message requesting a return of a previously purchased product, analyzing, by executing an instruction with at least one processor, the message to determine whether the message was transmitted by an automated entity, after determining that the message was transmitted by the automated entity, performing a responsive action to prevent future automated messages from the remote entity.

Example 80 includes the method of example 79, wherein the remote entity is a consumer advocacy system.

Example 81 includes the method of example 80, wherein the message is sent by the consumer advocacy system on behalf of a consumer.

Example 82 includes the method of any one of examples 79 through 81, wherein the message includes identifying information of the consumer.

Example 83 includes a method for monitoring performance of a consumer advocacy activity, the method comprising accessing a communication log, the communication log including a message sent to an entity and corresponding message received from the entity, generating a prompt, the prompt to cause a large language model to evaluate a progress of a conversation represented by the communication log, obtaining a response from the large language model, and evaluating the response to determine whether an objective of the consumer advocacy activity has been accomplished.

Example 84 includes the method of example 83, further including parsing the response to determine values for one or more status variables.

Example 85 includes the method of example 83, wherein the prompt is to instruct the large language model to provide values for the one or more status variables in a parseable format.

Example 86 includes a method comprising generating, by executing an instruction with at least one processor, a prompt, the prompt to cause a large language model to generate a next message to be transmitted from a consumer advocacy system to an entity to advocate on behalf of a consumer, the prompt to include information identifying an objective of the conversation and information to identify the consumer, obtaining a response from the large language model, parsing the response to extract the next message to be transmitted from the consumer advocacy system to the entity, and causing the next message to be transmitted to the entity.

Example 87 includes the method of example 86, further including accessing a communication log, the communication log representing a conversation between the consumer advocacy system and the entity on behalf of the consumer, wherein the prompt further includes one or more messages included in the communication log.

Example 88 includes the method of any one of examples 86 through 87, wherein the prompt includes consumer preference information.

Example 89 includes the method of any one of examples 86 through 88, wherein the prompt is a first prompt and the response is a first response, and further including generating a second prompt to be provided to the large language model, the second prompt to cause the large language mode to determine a likelihood that the next message will to lead to achievement of the objective, evaluating a second response to the second prompt to determine whether the likelihood meets or exceeds a threshold likelihood, and the causing of the transmission of the next message occurs after the determination that the likelihood meets or exceeds the threshold likelihood.

Example 90 includes a method comprising accessing a request from a consumer to automate a return of a product to an entity, analyzing the request to determine a first likelihood that the entity will accept the return of the product, in response to the first likelihood that the entity will accept the return of the product meeting or exceeding a first threshold value determining whether the entity will accept the return of the product by delivery alone, in response to a determination that entity will accept the return of the product by delivery alone, providing the consumer with instructions for delivery of the product to be returned, and in response to a determination that the entity will not accept the return of the product by delivery alone, initiating an automated return of the product, and in response to the first likelihood that the entity will accept the return of the product not meeting or exceeding the first threshold value, providing the consumer with instructions for disposing of the product using a third party service.

Example 91 includes the method of example 90, wherein the disposing of the product using the third party service includes selling the product via a re-seller.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory computer readable medium comprising machine executable instructions to cause at least one programmable circuit to at least:
obtain a first message from a large language model based on a return request provided by a consumer, the return request associated with a previously purchased product to be returned to an entity;
cause transmission of the first message to the entity to request authorization of the return of the previously purchased product;
obtain a second message from the large language model, the second message based on the first message and a first response, the first response from the entity in response to the first message;
cause transmission of the second message to the entity to continue the request to return the previously purchased product; and
cause communication of a resolution message to inform the consumer of the resolution of the request to return the previously purchased product.

2. The at least one non-transitory computer readable medium of claim 1, wherein the resolution message is to instruct the consumer to deliver the previously purchased product to a location.

3. The at least one non-transitory computer readable medium of claim 1, wherein the resolution message includes an indication of a date by which a return activity is to occur.

4. The at least one non-transitory computer readable medium of claim 1, the machine executable instructions are to cause one or more of the at least one programmable circuit to:
analyze a conversation log to determine whether an objective of the return request has been accomplished, the conversation log including the first message, the first response, the second message, and a second response; and
generate the resolution message based on the conversation log.

5. The at least one non-transitory computer readable medium of claim 4, wherein the large language model is a first large language model, and to analyze the conversation log, at least one of the at least one programmable circuit is to obtain a third message from a second large language model based on the conversation log.

6. The at least one non-transitory computer readable medium of claim 5, wherein the first large language model is the same as the second large language model.

7. The at least one non-transitory computer readable medium of claim 4, wherein the instructions are to cause one or more of the at least one programmable circuit to determine a level of success of completion of the objective of the return request, the level of success including at least one of partial success, divergent success, or complete success.

8. The at least one non-transitory computer readable medium of claim 4, wherein the instructions are to cause one or more of the at least one programmable circuit to, after the determination that the objective of the return request has been accomplished:
record a consumer next task for resolution of the return of the previously purchased product;
record an entity next task for resolution of the return of the previously purchased product.

9. The at least one non-transitory computer readable medium of claim 8, wherein the consumer next task includes shipping the previously purchased product to a destination.

10. The at least one non-transitory computer readable medium of claim 1, wherein the instructions are to cause one or more of the at least one programmable circuit to access a plurality of statements from the entity to obtain the first response, a last one of the plurality of statements identified when a threshold amount of time has elapsed without receipt of a subsequent statement, the first response corresponding to a combination of the plurality of statements.

11. The at least one non-transitory computer readable medium of claim 1, wherein the instructions are to cause one or more of the at least one programmable circuit to:
analyze the first message to determine if the second message can be generated using a message template; and
generate the second message with the message template.

12. The at least one non-transitory computer readable medium of claim 11, wherein the analysis of whether the second message can be generated using the message template is based on a list of patterns and corresponding message templates, the second message generated based on the message template corresponding to a pattern that matches the first response.

13. The at least one non-transitory computer readable medium of claim 11, wherein the large language model is a first large language model, and the instructions are to cause one or more of the programmable circuit to, after a determination that the second message cannot be generated using the message template:
generate a second prompt based on the first response and the return request; and
obtain the second message from the first large language model based on the second prompt.

14. The at least one non-transitory computer readable medium of claim 1, wherein the first message, the first response, the second message, and a second response are stored in a conversation log, and the instructions are to cause one or more of the at least one programmable circuit to:
analyze the conversation log to identify similar response messages and corresponding subsequent messages;
generate a pattern representing similar response messages;
generate a message template representing similar corresponding subsequent messages; and
record the pattern and the message template.

15. The at least one non-transitory computer readable medium of claim 14, wherein the conversation log includes conversations from other product return activities.

16. The at least one non-transitory computer readable medium of claim 15, wherein to analyze the conversation log, the instructions are to cause one or more of the at least one programmable circuit to filter the conversation log to conversations associated with the entity.

17. The at least one non-transitory computer readable medium of claim 1, wherein the instructions are to cause one or more of the at least one programmable circuit to analyze an image of a receipt captured to identify the previously purchased product.

18. The at least one non-transitory computer readable medium of claim 1, wherein the instructions are to cause one or more of the at least one programmable circuit to analyze an email communication from the entity to identify the previously purchased product.

19. An apparatus comprising:
interface circuitry;
machine-readable instructions; and
at least one processor circuit to be programmed by the machine-readable instructions to:
obtain a first message from a large language model based on a return request provided by a consumer, the return request associated with a previously purchased product to be returned to an entity;
cause transmission of the first message to the entity to request authorization of the return of the previously purchased product;
obtain a second message from the large language model, the second message based on the first message and a first response, the first response from the entity in response to the first message;
cause transmission of the second message to the entity to continue the request to return the previously purchased product; and
cause transmission of a resolution message to inform the consumer of the resolution of the request to return the previously purchased product.

20. The apparatus of claim 19, wherein one or more of the at least one processor circuit is to:
access a purchase record of the previously purchased product from the entity; and
generate a prompt based on the purchase record, the first message obtained based on the prompt.

21. The apparatus of claim 20, wherein one or more of the at least one processor circuit is to identify a previous communication from the entity, and the prompt includes at least a portion of the previous communication.

22. The apparatus of claim 21, wherein the previous communication includes at least one of a policy, an answer to a frequently asked question, or an email message from the entity to the consumer.

23. The apparatus of claim 19, wherein to transmit the first message to the entity, one or more of the at least one processor circuit is to enter the first message into a web browser.

24. The apparatus of claim 19, wherein to transmit the first message to the entity, one or more of the at least one processor circuit is to cause transmission of a communication using a web socket.

25. The apparatus of claim 19, wherein the return request is received via an interaction of the consumer with a mobile device.

26. The apparatus of claim 19, wherein the return request is received using a first natural language, and the first message is obtained in a second natural language different from the first natural language.

27. The apparatus of claim 19, wherein the large language model is implemented at large language model circuitry that is separate from the apparatus.
